(19) United States
(12) Patent Application Publication
(10) Pub. No.: US 2015/0361293 A1
(43) Pub. Date: Dec. 17, 2015

(54) ACTIVE ENERGY RAY-CURABLE RESIN COMPOSITION, MANUFACTURING METHOD FOR ACTIVE ENERGY RAY-CURABLE RESIN COMPOSITION, COATING MATERIAL, COATING FILM, AND FILM

(71) Applicant: DIC Corporation, Tokyo (JP)

(72) Inventors: Masahiro Ito, Ichihara-shi (JP); Erika Imamura, Ichihara-shi (JP)

(21) Appl. No.: 14/409,166

(22) PCT Filed: Jun. 20, 2013
(86) PCT No.: PCT/JP2013/066948

§ 371 Date: Dec. 18, 2014

(30) Foreign Application Priority Data
Jun. 21, 2012 (JP) 2012-139701

(51) Int. Cl. C09D 133/14; C08K 3/36

(52) U.S. Cl. CPC C09D 133/14; C08K 3/36

(57) ABSTRACT

Provided are a coating with good blocking resistance, transparency, and scratch resistance, a laminated film including such a coating, an active-energy-radiation-curable resin composition, and a method for manufacturing such a resin composition. The laminated film includes a coating layer and a plastic film layer. The coating layer is made of a resin composition containing, as essential components, fine inorganic particles (A) and a resin component (b) in a mass ratio [(A)/(b)] of 30/70 to 60/40. The coating has an arithmetic mean roughness (Ra) of 1 to 30 nm and a haze of 1.4 or less for a thickness of 100 μm or less.

### TECHNICAL FIELD

The present invention relates to coatings with good blocking resistance, transparency, and scratch resistance, laminated films including such coatings, active-energy-radiation-curable resin compositions, and methods for manufacturing such resin compositions.

### BACKGROUND ART

Surface protective layers for protecting the surfaces of displays and molded plastic products from scratches are formed, for example, directly using a laminated film composed of a substrate film and a hard coat layer formed thereon as a surface protective film, or by transferring only a hard coat layer from a laminated film composed of a substrate film with release properties and a hard coat layer formed thereon for use as a protective layer. Laminated films used for these methods are stored in the form of a roll or stack. During storage, the hard coat layer formed on the outermost surface of a laminated film may adhere to the back surface of another laminated film, which is termed blocking. Blocking decreases the yield of laminated films and also decreases the production efficiency of displays and molded plastic products. Accordingly, there is a need for the development of a resin composition for hard coat layers with good blocking resistance.

One known resin composition for hard coat layers resistant to blocking contains 1.5 parts by mass of an acrylic copolymer having an SP value of 10.5 that is prepared by adding glycidyl methacrylate to the carboxyl groups of an acrylic copolymer of isobornyl methacrylate, methyl methacrylate, and methacrylic acid, and 98.5 parts by mass of pentaerythritol triacrylate having an SP value of 12.7 (see PTL 1). This resin composition, containing two resin components with different SP values, forms a coat layer having a relatively large arithmetic mean roughness (Ra), i.e., 50 to 240 nm, which indicates the roughness of a fine texture, and can thus be used to form a laminated film with good blocking resistance. However, the resulting coat layer has insufficient surface hardness and scratch resistance because the acrylic copolymer present in the resin composition has substantially no reactive groups. Accordingly, there is a need for the development of a resin composition for hard coat layers that can form a coat layer with good blocking resistance and high surface hardness.

### CITATION LIST

### Patent Literature

PTL 1: Japanese Unexamined Patent Application Publication No. 2008-62539

### SUMMARY OF INVENTION

### Technical Problem

An object of the present invention is to provide a coating with good blocking resistance, transparency, and scratch resistance, a laminated film including such a coating, an active-energy-radiation-curable resin composition, and a method for manufacturing such a resin composition.

### Solution to Problem

After conducting intensive research to achieve the above object, the inventors have discovered that a coating formed using a resin composition containing fine inorganic particles and a resin component and having an arithmetic mean roughness (Ra) of 1 to 30 nm has both good blocking resistance and good scratch resistance and also has good transparency even if the coating is thick, e.g., has a thickness of 100 μm. This discovery has led to the present invention.

Specifically, the present invention relates to a laminated film including a coating layer and a plastic film layer. The coating layer is formed by curing a resin composition containing, as essential components, fine inorganic particles (A) and a resin component (b) in a mass ratio [(A)/(b)] of 30/70 to 60/40. The coating has an arithmetic mean roughness (Ra) of 1 to 30 nm and a haze of 1.4 or less.

The present invention further relates to an active-energy-radiation-curable resin composition containing, as essential components, fine inorganic particles (A) having an average particle size of 95 to 250 nm, a resin component (B) having a (meth)acryloyl group in the molecular structure thereof, and an organic solvent (S1) having an oxyalkylene structure in the molecular structure thereof. The fine inorganic particles (A) are present in an amount of 30 to 55 parts by mass based on 100 parts by mass of the nonvolatile components.

The present invention further relates to an active-energy-radiation-curable resin composition containing, as essential components, fine inorganic particles (A) having an average particle size of 95 to 250 nm, a resin component (B) having a (meth)acryloyl group in the molecular structure thereof, and a ketone solvent (S2). The fine inorganic particles (A) are present in an amount of 45 to 60 parts by mass based on 100 parts by mass of the nonvolatile components.

The present invention further relates to a method for manufacturing an active-energy-radiation-curable resin composition using a wet ball mill including a vessel charged with media, a rotating shaft, stirring blades having an axis of rotation coaxial with the rotating shaft and configured to rotate as the rotating shaft rotates, a raw material inlet disposed on the vessel, a dispersion outlet disposed on the vessel, and a shaft seal disposed at a position where the rotating shaft extends through the vessel. The shaft seal includes two mechanical seal units, each including a seal portion sealed with an external seal liquid. The method includes supplying raw materials including, as essential components, fine inorganic particles (A) having an average particle size of 95 to 250 nm and a resin component (b) from the inlet to the vessel of the wet ball mill; mixing the raw materials with the media in the vessel with stirring by rotating the rotating shaft and the stirring blades to crush the fine inorganic particles (A) and to disperse the fine inorganic particles (A) in the other components; and discharging the dispersion from the outlet.

The present invention further relates to a coating composition containing the resin composition.

The present invention further relates to a coating made of the coating composition.

### Advantageous Effects of Invention

The present invention provides a coating with good blocking resistance, transparency, and scratch resistance, a laminated film including such a coating, an active-energy-radiation-curable resin composition, and a method for manufacturing such a resin composition.

### BRIEF DESCRIPTION OF DRAWINGS

FIG. 1 is a longitudinal sectional view of a wet ball mill that can be used in the manufacture of a resin composition according to the present invention.

FIG. 2 is a longitudinal sectional view of a shaft seal of the wet ball mill that can be used in the manufacture of the resin composition according to the present invention.

FIG. 3 is an analysis image, created with a scanning probe microscope (“SPM-9600” available from Shimadzu Corporation), of the surface of a resin coating layer of a laminated film prepared in Example 1.

### DESCRIPTION OF EMBODIMENTS

A laminated film according to the present invention includes a coating layer made of a resin composition containing fine inorganic particles (A) and a resin component (b) and having an arithmetic mean roughness (Ra) of 1 to 30 nm. Because the fine inorganic particles (A) are added to the resin component (b) to form a fine texture in the surface of the coating, the coating has sufficient blocking resistance even if it has a relatively small arithmetic mean roughness (Ra), i.e., 1 to 30 nm, and also has high surface hardness and good scratch resistance. Because the coating has a relatively small arithmetic mean roughness (Ra), i.e., 1 to 30 nm, it has a low haze and thus has high transparency even if it is thick, i.e., has a thickness of more than 30 μm. More specifically, the coating has a haze of 1.4 or less if it has a thickness of 100 μm or less.

In the present invention, the arithmetic mean roughness (Ra) of the coating is measured with a scanning probe microscope (“SPM-9600” available from Shimadzu Corporation).

In the present invention, the haze of the coating is measured with a haze meter (“Haze Computer HZ-2” available from Suga Test Instruments Co., Ltd.).

The fine inorganic particles (A) used in the present invention preferably have an average particle size of 95 to 250 nm, more preferably 100 to 150 nm. Such fine inorganic particles can form a coating having both good blocking resistance and good transparency and also having good scratch resistance.

In the present invention, the average particle size of the fine inorganic particles (A) in the active-energy-radiation-curable resin composition is measured with a particle size analyzer (“ELSZ-2” available Otsuka Electronics Co., Ltd.).

The fine inorganic particles (A) used in the present invention may be prepared by dispersing fine inorganic particles (a) used as a raw material in the resin component (x). Examples of fine inorganic particles (a) include fine particles of silica, alumina, zirconia, titania, barium titanate, and antimony trioxide. These materials may be used alone or in combination.

Preferred among these fine inorganic particles (a) are fine silica particles, which are readily available and are easy to handle. Examples of fine silica particles include fine wet-process silica particles and fine dry-process silica particles. Examples of fine wet-process silica particles include fine silica particles prepared by neutralizing sodium silicate with a mineral acid. If the fine inorganic particles (a) are fine wet-process silica particles, it is preferred to use fine wet-process silica particles with an average particle size of 95 to 250 nm. Such fine wet-process silica particles facilitate adjustment of the average particle size of the resulting fine inorganic particles (A) to the above preferred range. Examples of fine dry-process silica particles include fine silica particles prepared by combusting silicon tetrachloride in an oxygen or hydrogen flame. If the fine inorganic particles (a) are fine dry-process silica particles, it is preferred to use aggregated fine dry-process silica particles with an average primary particle size of 3 to 100 nm, more preferably 5 to 50 nm. Such fine dry-process silica particles facilitate adjustment of the average particle size of the resulting fine inorganic particles (A) to the above preferred range.

Preferred among these fine silica particles are fine dry-process silica particles, which can form a coating having better transparency and also having high surface hardness and good scratch resistance.

In the present invention, functional groups may be introduced to the surface of the fine inorganic particles (a) using various silane coupling agents. In particular, functional groups are preferably introduced to the surface of the fine inorganic particles (a). Such fine inorganic particles can form a coating having a higher surface hardness and a better scratch resistance.

Examples of silane coupling agents include vinylsilane coupling agents such as vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, hydrochlorides of N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, and N-(vinylbenzyl)-2-aminoethyl-3-aminopropyltrimethoxysilane, special aminosilanes, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl) tetrasulfide, 3-isocyanatopropyltriethoxysilane, allyltrichlorosilane, allyltriethoxysilane, allyltrimethoxysilane, diethoxymethylvinylsilane, trichlorovinylsilane, vinyltrichlorosilane, vinyltrimethoxysilane, vinyltriethoxysilane, and vinyltris(2-methoxyethoxy)silane;

epoxysilane coupling agents such as diethoxy(glycidyloxypropyl)methylsilane, 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane; styrylsilane coupling agents such as p-styryltrimethoxysilane;

(meth)acryloxysilane coupling agents such as 3-methacryloxypropylmethyldimethoxysilane, 3-acryloxypropyltrimethoxysilane, 3-methacryloxypropyltrimethoxysilane, 3-methacryloxypropylmethyldiethoxysilane, and 3-methacryloxypropyltriethoxysilane;

aminosilane coupling agents such as N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane;

ureidosilane coupling agents such as 3-ureidopropyltriethoxysilane;

chloropropylsilane coupling agents such as 3-chloropropyltrimethoxysilane;

mercaptosilane coupling agents such as 3-mercaptopropylmethyldimethoxysilane and 3-mercaptopropyltrimethoxysilane;

silyl sulfide coupling agents such as bis(triethoxysilylpropyl) tetrasulfide; and

isocyanatosilane coupling agents such as 3-isocyanatopropyltriethoxysilane. These silane coupling agents may be used alone or in combination. Preferred among these silane coupling agents are (meth)acryloxysilane coupling agents, more preferably 3-acryloxypropyltrimethoxysilane and 3-methacryloxypropyltrimethoxysilane. Such silane coupling agents can form a cured coating having high surface hardness and good scratch resistance and also having high transparency.

The resin composition used in the present invention contains the fine inorganic particles (A) and the resin component (b) as essential components. The fine inorganic particles (A) and the resin component (b) are preferably present in a mass ratio [(A)/(b)] of 30/70 to 60/40, more preferably 35/65 to 55/45. Such a resin composition can form a coating having both good blocking resistance and good transparency and also having high surface hardness and good scratch resistance.

The resin component (b) used in the present invention may be selected from a wide variety of resins used for coating applications. Preferably, the resin component (b) contains a resin component (B) having a (meth)acryloyl group in the molecular structure thereof. Such a resin component allows the fine inorganic particles (A) to be stably dispersed and can be readily cured by irradiation with active energy radiation such as ultraviolet radiation.

The resin component (B) having a (meth)acryloyl group in the molecular structure thereof may be selected from, for example, a (meth)acrylate monomer (M), an acrylic polymer (X) having (meth)acryloyl groups in the molecular structure thereof, a urethane (meth)acrylate (U), and an epoxy (meth)acrylate (E).

Examples of (meth)acrylate monomers (M) include mono(meth)acrylates such as 2-hydroxyethyl (meth)acrylate, 2-hydroxypropyl (meth)acrylate, 2-hydroxybutyl (meth)acrylate, n-butyl (meth)acrylate, isobutyl (meth)acrylate, t-butyl (meth)acrylate, glycidyl (meth)acrylate, acryloylmorpholine, N-vinylpyrrolidone, tetrahydrofurfuryl acrylate, cyclohexyl (meth)acrylate, 2-ethylhexyl (meth)acrylate, isobornyl (meth)acrylate, isodecyl (meth)acrylate, lauryl (meth)acrylate, tridecyl (meth)acrylate, cetyl (meth)acrylate, stearyl (meth)acrylate, benzyl (meth)acrylate, 2-ethoxyethyl (meth)acrylate, 3-methoxybutyl (meth)acrylate, ethylcarbitol (meth)acrylate, phosphoric acid (meth)acrylate, ethylene-oxide-modified phosphoric acid (meth)acrylate, phenoxy (meth)acrylate, ethylene-oxide-modified phenoxy (meth)acrylate, propylene-oxide-modified phenoxy (meth)acrylate, nonylphenol (meth)acrylate, ethylene-oxide-modified nonylphenol (meth)acrylate, propylene-oxide-modified nonylphenol (meth)acrylate, methoxydiethylene glycol (meth)acrylate, methoxypolyethylene glycol (meth)acrylate, methoxypropylene glycol (meth)acrylate, 2-(meth)acryloyloxyethyl-2-hydroxypropyl phthalate, 2-hydroxy-3-phenoxypropyl (meth)acrylate, 2-(meth)acryloyloxyethyl hydrogen phthalate, 2-(meth)acryloyloxypropyl hydrogen phthalate, 2-(meth)acryloyloxypropyl hydrogen hexahydrophthalate, 2-(meth)acryloyloxypropyl hydrogen tetrahydrophthalate, dimethylaminoethyl (meth)acrylate, trifluoroethyl (meth)acrylate, tetrafluoropropyl (meth)acrylate, hexafluoropropyl (meth)acrylate, octafluoropropyl (meth)acrylate, octafluoropropyl (meth)acrylate, and adamantyl mono(meth)acrylate;

di(meth)acrylates such as butanediol di(meth)acrylate, hexanediol di(meth)acrylate, ethoxylated hexanediol di(meth)acrylate, propoxylated hexanediol di(meth)acrylate, diethylene glycol di(meth)acrylate, polyethylene glycol di(meth)acrylate, polypropylene glycol di(meth)acrylate, neopentyl glycol di(meth)acrylate, ethoxylated neopentyl glycol di(meth)acrylate, and neopentyl glycol hydroxypivalate di(meth)acrylate;

tri(meth)acrylates such as trimethylolpropane tri(meth)acrylate, ethoxylated trimethylolpropane tri(meth)acrylate, propoxylated trimethylolpropane tri(meth)acrylate, tris(2-hydroxyethyl) isocyanurate tri(meth)acrylate, and glycerol tri(meth)acrylate;

tetra- or higher functional (meth)acrylates such as pentaerythritol tri(meth)acrylate, dipentaerythritol tri(meth)acrylate, ditrimethylolpropane tri(meth)acrylate, pentaerythritol tetra(meth)acrylate, ditrimethylolpropane tetra(meth)acrylate, dipentaerythritol tetra(meth)acrylate, dipentaerythritol penta(meth)acrylate, ditrimethylolpropane penta(meth)acrylate, dipentaerythritol hexa(meth)acrylate, and ditrimethylolpropane hexa(meth)acrylate; and

(meth)acrylates prepared by modifying some of the (meth)acryloyl groups of the above (meth)acrylates with compounds such as ε-caprolactone and cyclic polyethers.

Preferred among these (meth)acrylate monomers (M) are di- or higher functional (meth)acrylates, more preferably tri(meth)acrylates and tetra- or higher functional (meth)acrylates. Such compounds allow the fine inorganic particles (A) to be stably dispersed and can form a cured coating having high surface hardness and good scratch resistance.

The acrylic polymer (X) having (meth)acryloyl groups in the molecular structure thereof may be, for example, a polymer prepared by reacting an acrylic polymer (Y) prepared by polymerizing, as an essential component, a compound (y) having a reactive functional group and a (meth)acryloyl group, with a compound (z) having a functional group capable of reacting with the reactive functional group of the compound (y) and a (meth)acryloyl group.

More specifically, the acrylic polymer (X) having (meth)acryloyl groups in the molecular structure thereof may be, for example, an acrylic polymer (X1) prepared by reacting an acrylic polymer (Y1) prepared by polymerizing, as an essential component, a compound (y1) having an epoxy group and a (meth)acryloyl group, with a compound (z1) having a carboxyl group and a (meth)acryloyl group; an acrylic polymer (X2) prepared by reacting an acrylic polymer (Y2) prepared by polymerizing, as an essential component, a compound (y2) having a carboxyl group and a (meth)acryloyl group, with a compound (z2) having an epoxy group and a (meth)acryloyl group; or an acrylic polymer (X3) prepared by reacting an acrylic polymer (Y3) prepared by polymerizing, as an essential component, a compound (y3) having a hydroxyl group and a (meth)acryloyl group, with a compound (z3) having an isocyanate group and a (meth)acryloyl group.

The acrylic polymer (X1) will be described first.

The acrylic polymer (Y1) used as a raw material for the acrylic polymer (X1) may be a homopolymer of the compound (y1) having an epoxy group and a (meth)acryloyl group or may be a copolymer thereof with other polymerizable compounds (v1).

Examples of compounds (y1), having an epoxy group and a (meth)acryloyl group, used as a raw material for the acrylic polymer (Y1) include glycidyl (meth)acrylate, glycidyl α-ethyl(meth)acrylate, glycidyl α-n-propyl(meth)acrylate, glycidyl α-n-butyl(meth)acrylate, 3,4-epoxybutyl (meth)acrylate, 4,5-epoxypentyl (meth)acrylate, 6,7-epoxypentyl (meth)acrylate, 6,7-epoxypentyl α-ethyl(meth)acrylate, β-methylglycidyl (meth)acrylate, 3,4-epoxycyclohexyl (meth)acrylate, lactone-modified 3,4-epoxycyclohexyl (meth)acrylate, and vinylcyclohexene oxide. These compounds may be used alone or in combination. Preferred among these compounds are glycidyl (meth)acrylate, glycidyl α-ethyl(meth)acrylate, and glycidyl α-n-propyl(meth)acrylate, more preferably glycidyl (meth)acrylate, which provide good curability for the resulting acrylic polymer (X1).

Examples of other polymerizable compounds (v1) that can be copolymerized with the compound (y1) having an epoxy group and a (meth)acryloyl group in the manufacture of the acrylic polymer (Y1) include (meth)acrylic acid esters having an alkyl group with 1 to 22 carbon atoms, such as methyl (meth)acrylate, ethyl (meth)acrylate, propyl (meth)acrylate, n-butyl (meth)acrylate, t-butyl (meth)acrylate, hexyl (meth)acrylate, heptyl (meth)acrylate, octyl (meth)acrylate, nonyl (meth)acrylate, decyl (meth)acrylate, dodecyl (meth)acrylate, tetradecyl (meth)acrylate, hexadecyl (meth)acrylate, stearyl (meth)acrylate, octadecyl (meth)acrylate, and docosyl (meth)acrylate;

(meth)acrylic acid esters having an alicyclic alkyl group, such as cyclohexyl (meth)acrylate, isobornyl (meth)acrylate, dicyclopentanyl (meth)acrylate, and dicyclopentenyloxyethyl (meth)acrylate;

(meth)acrylic acid esters having an aromatic ring, such as benzoyloxyethyl (meth)acrylate, benzyl (meth)acrylate, phenylethyl (meth)acrylate, phenoxyethyl (meth)acrylate, phenoxydiethylene glycol (meth)acrylate, and 2-hydroxy-3-phenoxypropyl (meth)acrylate;

acrylic acid esters having a hydroxyalkyl group, such as hydroxyethyl (meth)acrylate, hydroxypropyl (meth)acrylate, hydroxybutyl (meth)acrylate, glycerol (meth)acrylate, lactone-modified hydroxyethyl (meth)acrylate, and (meth)acrylic acid esters having a polyalkylene glycol group, such as polyethylene glycol (meth)acrylate and polypropylene glycol (meth)acrylate;

unsaturated dicarboxylic acid esters such as dimethyl fumarate, diethyl fumarate, dibutyl fumarate, dimethyl itaconate, dibutyl itaconate, methyl ethyl fumarate, methyl butyl fumarate, and methyl ethyl itaconate;

styrenes such as styrene, α-methylstyrene, and chlorostyrene;

dienes such as butadiene, isoprene, piperylene, and dimethylbutadiene;

vinyl halides and vinylidene halides such as vinyl chloride and vinyl bromide;

unsaturated ketones such as methyl vinyl ketone and butyl vinyl ketone;

vinyl esters such as vinyl acetate and vinyl butyrate;

vinyl ethers such as methyl vinyl ether and butyl vinyl ether;

vinyl cyanides such as acrylonitrile, methacrylonitrile, and vinylidene cyanide;

acrylamide and alkyd-substituted amides thereof;

N-substituted maleimides such as N-phenylmaleimide and N-cyclohexylmaleimide;

fluorine-containing α-olefins such as vinyl fluoride, vinylidene fluoride, trifluoroethylene, chlorotrifluoroethylene, bromotrifluoroethylene, pentafluoropropylene, and hexafluoropropylene;

(per)fluoroalkyl perfluorovinyl ethers having a (per)fluoroalkyl group with 1 to 18 carbon atoms, such as trifluoromethyl trifluorovinyl ether, pentafluoroethyl trifluorovinyl ether, and heptafluoropropyl trifluorovinyl ether;

(per)fluoroalkyl (meth)acrylates having a (per)fluoroalkyl group with 1 to 18 carbon atoms, such as 2,2,2-trifluoroethyl (meth)acrylate, 2,2,3,3-tetrafluoropropyl (meth)acrylate, 1H,1H,5H-octafluoropentyl (meth)acrylate, 1H,1H,2H,2H-heptadecafluorodecyl (meth)acrylate, and perfluoroethyloxyethyl (meth)acrylate;

silyl-containing (meth)acrylates such as 3-methacryloxypropyltrimethoxysilane; and

N,N-dialkylaminoalkyl (meth)acrylates such as N,N-dimethylaminoethyl (meth)acrylate, N,N-diethylaminoethyl (meth)acrylate, and N,N-diethylaminopropyl (meth)acrylate. These compounds may be used alone or in combination.

Preferred among these other polymerizable compounds (v1) are (meth)acrylic acid esters having an alkyl group with 1 to 22 carbon atoms and (meth)acrylic acid esters having an alicyclic alkyl group, which provide good curability for the resulting acrylic polymer (X1) and high hardness and good scratch resistance for the resulting cured coating, more preferably (meth)acrylic acid esters having an alkyl group with 1 to 22 carbon atoms. Particularly preferred are methyl (meth)acrylate, ethyl (meth)acrylate, propyl (meth)acrylate, n-butyl (meth)acrylate, t-butyl (meth)acrylate, cyclohexyl (meth)acrylate, and isobornyl (meth)acrylate.

As described above, the acrylic polymer (Y1) may be a homopolymer of the compound (y1) having an epoxy group and a (meth)acryloyl group or may be a copolymer of the compound (y1) having an epoxy group and a (meth)acryloyl group with the other polymerizable compounds (v1). Preferred among these polymers is a polymer prepared by copolymerizing the compound (y1) having an epoxy group and a (meth)acryloyl group with the other polymerizable compounds (v1) in a mass ratio [compound (y1) having epoxy group and (meth)acryloyl group]/[other polymerizable compounds (v1)] of 20/80 to 95/5, more preferably 30/70 to 85/15. Such a polymer allows the fine inorganic particles (A) to be stably dispersed and can form a cured coating having high surface hardness and good scratch resistance.

The acrylic polymer (Y1) can be manufactured, for example, by addition polymerization of the compound (y1) alone or in combination with the compounds (v1) in the presence of a polymerization initiator in the temperature range of 60° C. to 150° C. The resulting acrylic polymer (Y1) may be, for example, a random copolymer, a block copolymer, or a graft copolymer. The polymerization may be performed, for example, by bulk polymerization, solution polymerization, suspension polymerization, or emulsion polymerization. Preferred among these methods is solution polymerization, by which the manufacture of the acrylic polymer (Y1) and the subsequent reaction of the acrylic polymer (Y1) with the compound (z1) having a carboxyl group and a (meth)acryloyl group can be continuously performed.

If the acrylic polymer (Y1) is manufactured by solution polymerization, it may be performed using a solvent having a boiling point of 80° C. or higher, taking into account the reaction temperature. Examples of such solvents include ketone solvents such as methyl ethyl ketone, methyl n-propyl ketone, methyl isopropyl ketone, methyl n-butyl ketone, methyl isobutyl ketone, methyl n-amyl ketone, methyl n-hexyl ketone, diethyl ketone, ethyl n-butyl ketone, di-n-propyl ketone, diisobutyl ketone, cyclohexanone, and phorone;

ether solvents such as n-butyl ether, diisoamyl ether, and dioxane;

glycol ether solvents such as ethylene glycol monomethyl ether, ethylene glycol dimethyl ether, ethylene glycol monoethyl ether, ethylene glycol diethyl ether, ethylene glycol monopropyl ether, ethylene glycol monoisopropyl ether, ethylene glycol monobutyl ether, diethylene glycol monomethyl ether, diethylene glycol dimethyl ether, diethylene glycol monoethyl ether, diethylene glycol diethyl ether, diethylene glycol monoisopropyl ether, diethylene glycol monobutyl ether, triethylene glycol monomethyl ether, triethylene glycol dimethyl ether, propylene glycol monomethyl ether, propylene glycol dimethyl ether, propylene glycol monopropyl ether, propylene glycol monobutyl ether, dipropylene glycol monomethyl ether, and dipropylene glycol dimethyl ether;

ester solvents such as n-propyl acetate, isopropyl acetate, n-butyl acetate, n-amyl acetate, ethylene glycol monomethyl ether acetate, ethylene glycol monoethyl ether acetate, diethylene glycol monomethyl ether acetate, diethylene glycol monoethyl ether acetate, propylene glycol monomethyl ether acetate, and ethyl-3-ethoxy propionate;

alcohol solvents such as isopropyl alcohol, n-butyl alcohol, isobutyl alcohol, diacetone alcohol, 3-methoxy-1-propanol, 3-methoxy-1-butanol, and 3-methyl-3-methoxybutanol; and

hydrocarbon solvents such as toluene, xylene, Solvesso 100, Solvesso 150, Swasol 1800, Swasol 310, Isopar E, Isopar G, Exxon Naphtha No. 5, and Exxon Naphtha No. 6. These solvents may be used alone or in combination.

Preferred among these solvents are ketone solvents and glycol ether solvents, more preferably methyl ethyl ketone, methyl isobutyl ketone, propylene glycol monomethyl ether, propylene glycol dimethyl ether, propylene glycol monopropyl ether, and propylene glycol monobutyl ether, even more preferably propylene glycol monomethyl ether. Such solvents are effective in dissolving the resulting acrylic polymer (Y1).

Examples of catalysts used in the manufacture of the acrylic polymer (Y1) include azo compounds such as 2,2′-azobisisobutyronitrile, 2,2′-azobis(2,4-dimethylvaleronitrile), and 2,2′-azobis(4-methoxy-2,4-dimethylvaleronitrile); and hydrogen peroxide and organic peroxides such as benzoyl peroxide, lauroyl peroxide, t-butyl peroxypivalate, t-butyl peroxyethylhexanoate, 1,1′-bis(t-butylperoxy)cyclohexane, t-amyl peroxy-2-ethylhexanoate, and t-hexyl peroxy-2-ethylhexanoate.

If the catalyst is a peroxide, it may be used in combination with a reducing agent, i.e., as a redox initiator.

Examples of compounds (z1), having a carboxyl group and a (meth)acryloyl group, used as a raw material for the acrylic polymer (X1) include carboxyl-containing polyfunctional (meth)acrylates prepared by reacting, with hydroxyl-containing polyfunctional (meth)acrylate monomers such as pentaerythritol triacrylate, unsaturated monocarboxylic acids such as (meth)acrylic acid, (acryloyloxy)acetic acid, 2-carboxyethyl acrylate, 3-carboxypropyl acrylate, 1-[2-(acryloyloxy)ethyl] succinate, 1-(2-acryloyloxyethyl) phthalate, 2-(acryloyloxy)ethyl hydrogen hexahydrophthalate, and lactone-modified derivatives thereof; unsaturated dicarboxylic acids such as maleic acid; and acid anhydrides such as succinic anhydride and maleic anhydride. These compounds may be used alone or in combination. Preferred among these compounds are (meth)acrylic acid, (acryloyloxy)acetic acid, 2-carboxyethyl acrylate, and 3-carboxypropyl acrylate, more preferably (meth)acrylic acid, which provide good curability for the resulting acrylic polymer (X1).

The acrylic polymer (X1) is prepared by reacting the acrylic polymer (Y1) with the compound (z1) having a carboxyl group and a (meth)acryloyl group. This reaction may be performed, for example, by preparing the acrylic polymer (Y1) by solution polymerization, adding to the reaction system the compound (z1) having a carboxyl group and a (meth)acryloyl group, and reacting the mixture in the temperature range of 60° C. to 150° C., optionally using a catalyst such as triphenylphosphine.

The (meth)acryloyl equivalent of the thus-prepared acrylic polymer (X1) is preferably 220 to 800 g/eq, more preferably 230 to 600 g/eq. Such an acrylic polymer allows the fine inorganic particles (A) to be stably dispersed and can form a cured coating having high surface hardness and good scratch resistance. The (meth)acryloyl equivalent of the acrylic polymer (X1) can be adjusted, for example, depending on the reaction ratio of the acrylic polymer (Y1) to the compound (z1) having a carboxyl group and a (meth)acryloyl group. Typically, the (meth)acryloyl equivalent of the resulting acrylic polymer (X1) can be easily adjusted to the above preferred range by reacting the acrylic polymer (Y1) with the compound (z1) such that the carboxyl groups of the compound (z1) are present in an amount of 0.8 to 1.1 mol per mole of epoxy groups of the acrylic polymer (Y1).

The acrylic polymer (X1) has hydroxyl groups formed by the reaction of epoxy groups with carboxyl groups in the molecular structure thereof. In the present invention, these hydroxyl groups may optionally be subjected to addition reaction with a compound (w) having an isocyanate group and a (meth)acryloyl group to adjust the acryloyl equivalent of the acrylic polymer (X1) to the above preferred range. The thus-prepared acrylic polymer (X1′) can be used as the acrylic polymer (X) in the present invention, as is the acrylic polymer (X1).

For example, the compound (w) having an isocyanate group and a (meth)acryloyl group may be a compound represented by general formula 1 below. Examples of such compounds include monomers having one isocyanate group and one (meth)acryloyl group, monomers having one isocyanate group and two (meth)acryloyl groups, monomers having one isocyanate group and three (meth)acryloyl groups, monomers having one isocyanate group and four (meth)acryloyl groups, and monomers having one isocyanate group and five (meth)acryloyl groups.

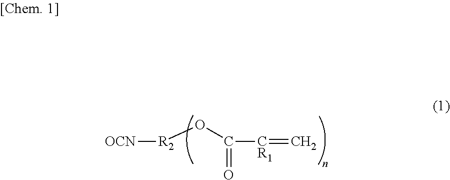

In general formula (1), R₁ is hydrogen or methyl, R₂ is alkylene having 2 to 4 carbon atoms, and n is an integer of 1 to 5.

Examples of commercially available compounds (w) having an isocyanate group and a (meth)acryloyl group include 2-acryloyloxyethyl isocyanate (trade name “Karenz AOI”, available from Showa Denko K.K.), 2-metacryloyloxyethyl isocyanate (trade name “Karenz MOI”, available from Showa Denko K.K.), and 1,1-bis(acryloyloxymethyl)ethyl isocyanate (trade name “Karenz BEI”, available from Showa Denko K.K.).

Other examples of compounds (w) include compounds prepared by adding a hydroxyl-containing (meth)acrylate to one of the isocyanate groups of a diisocyanate. Examples of diisocyanates used for this reaction include aliphatic diisocyanates such as butane-1,4-diisocyanate, hexamethylene diisocyanate, 2,2,4-trimethylhexamethylene diisocyanate, 2,4,4-trimethylhexamethylene diisocyanate, xylylene diisocyanate, and m-tetramethylxylylene diisocyanate;

alicyclic diisocyanates such as cyclohexane-1,4-diisocyanate, isophorone diisocyanate, lysine diisocyanate, dicyclohexylmethane-4,4′-diisocyanate, 1,3-bis(isocyanatomethyl)cyclohexane, and methylcyclohexane diisocyanate; and

aromatic diisocyanates such as 1,5-naphthylene diisocyanate, 4,4′-diphenylmethane diisocyanate, 4,4′-diphenyldimethylmethane diisocyanate, 4,4′-dibenzyl diisocyanate, dialkyldiphenylmethane diisocyanate, tetraalkyldiphenylmethane diisocyanate, 1,3-phenylene diisocyanate, 1,4-phenylene diisocyanate, and tolylene diisocyanate. These compounds may be used alone or in combination.

Examples of hydroxyl-containing (meth)acrylates used for this reaction include aliphatic (meth)acrylates such as 2-hydroxyethyl acrylate, 2-hydroxypropyl acrylate, 4-hydroxybutyl acrylate, glycerol diacrylate, trimethylolpropane diacrylate, pentaerythritol triacrylate, and dipentaerythritol pentaacrylate; and

(meth)acrylates having an aromatic ring in the molecular structure thereof, such as 4-hydroxyphenyl acrylate, β-hydroxyphenethyl acrylate, 4-hydroxyphenethyl acrylate, 1-phenyl-2-hydroxyethyl acrylate, 3-hydroxy-4-acetylphenyl acrylate, and 2-hydroxy-3-phenoxypropyl acrylate. These compounds may be used alone or in combination.

The acrylic polymer (X1) may be reacted with the compound (w) having an isocyanate group and a (meth)acryloyl group, for example, by adding the compound (w) having an isocyanate group and a (meth)acryloyl group dropwise to the system containing the acrylic polymer (X1) manufactured by the method described above and heating it to 50° C. to 120° C.

Preferred among the acrylic polymers (X1) and (X1′) is the acrylic polymer (X1), which allows the fine inorganic particles (A) to be stably dispersed.

The acrylic polymer (X2) will then be described.

The acrylic polymer (Y2) used as a raw material for the acrylic polymer (X2) may be a homopolymer of the compound (y2) having a carboxyl group and a (meth)acryloyl group or may be a copolymer thereof with other polymerizable compounds (v2).

Examples of compounds (y2), having a carboxyl group and a (meth)acryloyl group, used as a raw material for the acrylic polymer (Y2) include carboxyl-containing polyfunctional (meth)acrylates prepared by reacting, with hydroxyl-containing polyfunctional (meth)acrylate monomers such as pentaerythritol triacrylate, unsaturated monocarboxylic acids such as (meth)acrylic acid, (acryloyloxy)acetic acid, 2-carboxyethyl acrylate, 3-carboxypropyl acrylate, 1-[2-(acryloyloxy)ethyl] succinate, 1-(2-acryloyloxyethyl) phthalate, 2-(acryloyloxy)ethyl hydrogen hexahydrophthalate, and lactone-modified derivatives thereof; unsaturated dicarboxylic acids such as maleic acid; and acid anhydrides such as succinic anhydride and maleic anhydride. These compounds may be used alone or in combination. Preferred among these compounds are (meth)acrylic acid, (acryloyloxy)acetic acid, 2-carboxyethyl acrylate, and 3-carboxypropyl acrylate, more preferably (meth)acrylic acid, which allow the fine inorganic particles (A) to be stably dispersed and can form a cured coating having high surface hardness and good scratch resistance.

Examples of other polymerizable compounds (v2) that can be copolymerized with the compound (y2) having a carboxyl group and a (meth)acryloyl group in the manufacture of the acrylic polymer (Y2) include the various compounds listed as examples of compounds (v1). These compounds may be used alone or in combination. Preferred among these compounds are (meth)acrylic acid esters having an alkyl group with 1 to 22 carbon atoms and (meth)acrylic acid esters having an alicyclic alkyl group, which provide good curability for the resulting acrylic polymer (X2) and high hardness and good scratch resistance for the resulting cured coating, more preferably (meth)acrylic acid esters having an alkyl group with 1 to 22 carbon atoms. Particularly preferred are methyl (meth)acrylate, ethyl (meth)acrylate, propyl (meth)acrylate, n-butyl (meth)acrylate, and t-butyl (meth)acrylate.

As described above, the acrylic polymer (Y2) may be a homopolymer of the compound (y2) having a carboxyl group and a (meth)acryloyl group or may be a copolymer of the compound (y2) having a carboxyl group and a (meth)acryloyl group with the other polymerizable compounds (v2). Preferred among these polymers is a polymer prepared by copolymerizing the compound (y2) having a carboxyl group and a (meth)acryloyl group with the other polymerizable compounds (v2) in a mass ratio [compound (y2) having carboxyl group and (meth)acryloyl group]/[other polymerizable compounds (v2)] of 20/80 to 95/5, more preferably 30/70 to 85/15. Such a polymer allows the fine inorganic particles (A) to be stably dispersed and can form a cured coating having high surface hardness and good scratch resistance.

The acrylic polymer (Y2) can be manufactured, for example, by addition polymerization of the compound (y2) alone or in combination with the compounds (v2) in the presence of a polymerization initiator in the temperature range of 60° C. to 150° C. The resulting acrylic polymer (Y2) may be, for example, a random copolymer, a block copolymer, or a graft copolymer. The polymerization may be performed, for example, by bulk polymerization, solution polymerization, suspension polymerization, or emulsion polymerization. Preferred among these methods is solution polymerization, by which the manufacture of the acrylic polymer (Y2) and the subsequent reaction of the acrylic polymer (Y2) with the compound (z2) having an epoxy group and a (meth)acryloyl group can be continuously performed.

If the acrylic polymer (Y2) is manufactured by solution polymerization, it may be performed using the various solvents listed as examples of solvents used for solution polymerization in the manufacture of the acrylic polymer (Y1). These solvents may be used alone or in combination. Preferred among these solvents are ketone solvents and glycol ether solvents, more preferably methyl ethyl ketone, methyl isobutyl ketone, propylene glycol monomethyl ether, propylene glycol dimethyl ether, propylene glycol monopropyl ether, and propylene glycol monobutyl ether, even more preferably propylene glycol monomethyl ether. Such solvents are effective in dissolving the resulting acrylic polymer (Y2).

Examples of catalysts used in the manufacture of the acrylic polymer (Y2) include the various catalysts listed as examples of catalysts used in the manufacture of the acrylic polymer (Y1).

Examples of compounds (z2), having an epoxy group and a (meth)acryloyl group, used as a raw material for the acrylic polymer (X2) include glycidyl (meth)acrylate, glycidyl α-ethyl(meth)acrylate, glycidyl α-n-propyl(meth)acrylate, glycidyl α-n-butyl(meth)acrylate, 3,4-epoxybutyl (meth)acrylate, 4,5-epoxypentyl (meth)acrylate, 6,7-epoxypentyl (meth)acrylate, 6,7-epoxypentyl α-ethyl(meth)acrylate, β-methylglycidyl (meth)acrylate, 3,4-epoxycyclohexyl (meth)acrylate, lactone-modified 3,4-epoxycyclohexyl (meth)acrylate, and vinylcyclohexene oxide. These compounds may be used alone or in combination. Preferred among these compounds are glycidyl (meth)acrylate, glycidyl α-ethyl(meth)acrylate, and glycidyl α-n-propyl(meth)acrylate, which provide good curability for the resulting acrylic polymer (X1).

The acrylic polymer (X2) is prepared by reacting the acrylic polymer (Y2) with the compound (z2) having an epoxy group and a (meth)acryloyl group. This reaction may be performed, for example, by preparing the acrylic polymer (Y2) by solution polymerization, adding to the reaction system the compound (z2) having an epoxy group and a (meth)acryloyl group, and reacting the mixture in the temperature range of 60° C. to 150° C., optionally using a catalyst such as triphenylphosphine.

The (meth)acryloyl equivalent of the thus-prepared acrylic polymer (X2) is preferably 220 to 800 g/eq, more preferably 225 to 600 g/eq. Such an acrylic polymer allows the fine inorganic particles (A) to be stably dispersed and can form a cured coating having high surface hardness and good scratch resistance. The (meth)acryloyl equivalent of the acrylic polymer (X2) can be adjusted, for example, depending on the reaction ratio of the acrylic polymer (Y2) to the compound (z2) having an epoxy group and a (meth)acryloyl group. Typically, the (meth)acryloyl equivalent of the resulting acrylic polymer (X2) can be easily adjusted to the above preferred range by reacting the acrylic polymer (Y2) with the compound (z2) such that the epoxy groups of the compound (z2) are present in an amount of 0.8 to 1.1 mol per mole of carboxyl groups of the acrylic polymer (Y2).

The acrylic polymer (X2) has hydroxyl groups formed by the reaction of epoxy groups with carboxyl groups in the molecular structure thereof. In the present invention, these hydroxyl groups may optionally be subjected to addition reaction with the compound (w) having an isocyanate group and a (meth)acryloyl group to adjust the acryloyl equivalent of the acrylic polymer (X2) to the above preferred range. The thus-prepared acrylic polymer (X2′) can be used as the acrylic polymer (X) in the present invention, as is the acrylic polymer (X2).

The acrylic polymer (X2) may be reacted with the compound (w) having an isocyanate group and a (meth)acryloyl group, for example, by adding the compound (w) having an isocyanate group and a (meth)acryloyl group dropwise to the system containing the acrylic polymer (X2) manufactured by the method described above and heating it to 50° C. to 120° C.

Preferred among the acrylic polymers (X2) and (X2′) is the acrylic polymer (X2), which allows the fine inorganic particles (A) to be stably dispersed.

The acrylic polymer (X3) will then be described.

The acrylic polymer (Y3) used as a raw material for the acrylic polymer (X3) may be a homopolymer of the compound (y3) having a hydroxyl group and a (meth)acryloyl group or may be a copolymer thereof with other polymerizable compounds (v3).

Examples of compounds (y3), having a hydroxyl group and a (meth)acryloyl group, used as a raw material for the acrylic polymer (Y3) include 2-hydroxyethyl acrylate, 2-hydroxypropyl acrylate, 4-hydroxybutyl acrylate, 2,3-dihydroxypropyl acrylate, 2-hydroxyethyl methacrylate, 2-hydroxypropyl methacrylate, 4-hydroxybutyl methacrylate, and 2,3-dihydroxypropyl methacrylate. These compounds may be used alone or in combination. Preferred among these compounds are 2-hydroxyethyl acrylate and 2-hydroxypropyl acrylate, which allow the fine inorganic particles (A) to be stably dispersed and can form a cured coating having high surface hardness and good scratch resistance.

Examples of other polymerizable compounds (v3) that can be copolymerized with the compound (y3) having a hydroxyl group and a (meth)acryloyl group in the manufacture of the acrylic polymer (Y3) include the various compounds listed as examples of compounds (v1). These compounds may be used alone or in combination. Preferred among these compounds are (meth)acrylic acid esters having an alkyl group with 1 to 22 carbon atoms and (meth)acrylic acid esters having an alicyclic alkyl group, which provide good curability for the resulting acrylic polymer (X2) and high hardness and good scratch resistance for the resulting cured coating, more preferably (meth)acrylic acid esters having an alkyl group with 1 to 22 carbon atoms. Particularly preferred are methyl (meth)acrylate, ethyl (meth)acrylate, propyl (meth)acrylate, n-butyl (meth)acrylate, and t-butyl (meth)acrylate.

As described above, the acrylic polymer (Y3) may be a homopolymer of the compound (y3) having a hydroxyl group and a (meth)acryloyl group or may be a copolymer of the compound (y3) having a hydroxyl group and a (meth)acryloyl group with the other polymerizable compounds (v3). Preferred among these polymers is a polymer prepared by copolymerizing the compound (y3) having a hydroxyl group and a (meth)acryloyl group with the other polymerizable compounds (v3) in a mass ratio [compound (y3) having hydroxyl group and (meth)acryloyl group]/[other polymerizable compounds (v3)] of 20/80 to 95/5, more preferably 30/70 to 85/15. Such a polymer allows the fine inorganic particles (A) to be stably dispersed and can form a cured coating having high surface hardness and good scratch resistance.

The acrylic polymer (Y3) can be manufactured, for example, by addition polymerization of the compound (y3) alone or in combination with the compounds (v3) in the presence of a polymerization initiator in the temperature range of 60° C. to 150° C. The resulting acrylic polymer (Y3) may be, for example, a random copolymer, a block copolymer, or a graft copolymer. The copolymerization may be performed, for example, by bulk polymerization, solution polymerization, suspension polymerization, or emulsion polymerization. Preferred among these methods is solution polymerization, by which the manufacture of the acrylic polymer (Y3) and the subsequent reaction of the acrylic polymer (Y3) with the compound (z3) having an isocyanate group and a (meth)acryloyl group can be continuously performed.

If the acrylic polymer (Y3) is manufactured by solution polymerization, it may be performed using the various solvents listed as examples of solvents used for solution polymerization in the manufacture of the acrylic polymer (Y1). These solvents may be used alone or in combination. Preferred among these solvents are ketone solvents and glycol ether solvents, more preferably methyl ethyl ketone, methyl isobutyl ketone, propylene glycol monomethyl ether, propylene glycol dimethyl ether, propylene glycol monopropyl ether, and propylene glycol monobutyl ether, even more preferably propylene glycol monomethyl ether. Such solvents are effective in dissolving the resulting acrylic polymer (Y3).

Examples of catalysts used in the manufacture of the acrylic polymer (Y3) include the various catalysts listed as examples of catalysts used in the manufacture of the acrylic polymer (Y1).

Examples of compounds (z3), having an isocyanate group and a (meth)acryloyl group, used as a raw material for the acrylic polymer (X3) include the various compounds listed as examples of compounds (w) having an isocyanate group and a (meth)acryloyl group. These compounds may be used alone or in combination. Preferred among these compounds are compounds having two or more (meth)acryloyl groups per molecule, including 1,1-bis(acryloyloxymethyl)ethyl isocyanate, which provide good curability for the resulting acrylic polymer (X3).

The acrylic polymer (X3) is prepared by reacting the acrylic polymer (Y3) with the compound (z3) having an isocyanate group and a (meth)acryloyl group. This reaction may be performed, for example, by preparing the acrylic polymer (Y3) by solution polymerization, adding to the reaction system the compound (z3) having an isocyanate group and a (meth)acryloyl group, and reacting the mixture in the temperature range of 50° C. to 120° C., optionally using a catalyst such as tin(II) octoate.

The (meth)acryloyl equivalent of the thus-prepared acrylic polymer (X3) is preferably 220 to 800 g/eq, more preferably 225 to 600 g/eq. Such an acrylic polymer allows the fine inorganic particles (A) to be stably dispersed and can form a cured coating having high surface hardness and good scratch resistance. The (meth)acryloyl equivalent of the acrylic polymer (X3) can be adjusted, for example, depending on the reaction ratio of the acrylic polymer (Y3) to the compound (z3) having an isocyanate group and a (meth)acryloyl group. Typically, the (meth)acryloyl equivalent of the resulting acrylic polymer (X3) can be easily adjusted to the above preferred range by reacting the acrylic polymer (Y3) with the compound (z3) such that the isocyanate groups of the compound (z3) are present in an amount of 0.7 to 0.9 mol per mole of hydroxyl groups of the acrylic polymer (Y3).

The acrylic polymer (X) having (meth)acryloyl groups in the molecular structure thereof preferably has a weight average molecular weight (Mw) of 3,000 to 80,000, more preferably 8,000 to 50,000, even more preferably 10,000 to 45,000. Such an acrylic polymer is more effective in dispersing the fine inorganic particles (A) and provides a viscosity suitable for coating for the resin composition.

In the present invention, the weight average molecular weight (Mw) and the number average molecular weight (Mn) are measured using a gel permeation chromatograph (GPC) under the following conditions:

Measurement instrument: HLC-8220 from Tosoh Corporation Columns: Guard Column H_{XL}-H from Tosoh Corporation
+TSKgel G5000H_{XL} from Tosoh Corporation
+TSKgel G4000H_{XL} from Tosoh Corporation
+TSKgel G3000H_{XL} from Tosoh Corporation
+TSKgel G2000H_{XL} from Tosoh Corporation

Detector: differential refractive index (RI) detector

Data processing: SC-8010 from Tosoh Corporation

Measurement conditions:
Column temperature: 40° C.
Solvent: tetrahydrofuran
Flow rate: 1.0 mL/min

Standards: polystyrene

Sample: microfiltered tetrahydrofuran solution with resin solids content of 0.4% by weight (100 μL)

As described above, the (meth)acryloyl equivalent of the acrylic polymer (X) having (meth)acryloyl groups in the molecular structure thereof is preferably 220 to 800 g/eq, more preferably 225 to 600 g/eq. Such an acrylic polymer allows the fine inorganic particles (A) to be stably dispersed and can form a cured coating having high surface hardness and good scratch resistance.

The acrylic polymer (X) is preferably selected from the acrylic polymers (X1) and (X2), which are effective in dispersing the fine inorganic particles (A) and provide good storage stability for the active-energy-radiation-curable resin composition. The acrylic polymers (X1) and (X2) preferably have a hydroxyl value of 70 to 260 mg KOH/g, more preferably 100 to 250 mg KOH/g. Such an acrylic polymer allows the fine inorganic particles (A) to be more stably dispersed.

Particularly preferred is the acrylic polymer (X1), which is easier to synthesize, more preferably an acrylic polymer prepared using glycidyl (meth)acrylate as the compound (y1) and (meth)acrylic acid as the compound (z1).

The urethane (meth)acrylate (U) may be, for example, a reaction product of a polyisocyanate (u1) with a compound (u2) having a hydroxyl group and a (meth)acryloyl group in the molecular structure thereof.

Examples of polyisocyanates (u1) used as a raw material for the urethane (meth)acrylate (U) include various diisocyanate monomers and isocyanurate polyisocyanates having an isocyanurate ring structure in the molecule thereof.

Examples of diisocyanate monomers include aliphatic diisocyanates such as butane-1,4-diisocyanate, hexamethylene diisocyanate, 2,2,4-trimethylhexamethylene diisocyanate, 2,4,4-trimethylhexamethylene diisocyanate, xylylene diisocyanate, and m-tetramethylxylylene diisocyanate;

alicyclic diisocyanates such as cyclohexane-1,4-diisocyanate, isophorone diisocyanate, lysine diisocyanate, dicyclohexylmethane-4,4′-diisocyanate, 1,3-bis(isocyanatomethyl)cyclohexane, and methylcyclohexane diisocyanate; and

aromatic diisocyanates such as 1,5-naphthylene diisocyanate, 4,4′-diphenylmethane diisocyanate, 4,4′-diphenyldimethylmethane diisocyanate, 4,4′-dibenzyl diisocyanate, dialkyldiphenylmethane diisocyanate, tetraalkyldiphenylmethane diisocyanate, 1,3-phenylene diisocyanate, 1,4-phenylene diisocyanate, and tolylene diisocyanate.

Examples of isocyanurate polyisocyanates having an isocyanurate ring structure in the molecule thereof include reaction products of diisocyanate monomers with monoalcohols and/or diols. Examples of diisocyanate monomers used in this reaction include the various diisocyanate monomers listed above, which may be used alone or in combination. Examples of monoalcohols used in this reaction include hexanol, octanol, n-decanol, n-undecanol, n-dodecanol, n-tridecanol, n-tetradecanol, n-pentadecanol, n-heptadecanol, n-octadecanol, and n-nonadecanol. Examples of diols used in this reaction include ethylene glycol, diethylene glycol, propylene glycol, 1,3-propanediol, 1,4-butanediol, 1,3-butanediol, 3-methyl-1,3-butanediol, 1,5-pentanediol, neopentyl glycol, and 1,6-hexanediol. These monoalcohols and diols may be used alone or in combination.

Preferred among these polyisocyanates (u1) are diisocyanate monomers, which can form a cured coating with good scratch resistance, more preferably aliphatic diisocyanates and alicyclic diisocyanates.

Examples of compounds (u2), having a hydroxyl group and a (meth)acryloyl group in the molecular structure thereof, used as a raw material for the urethane (meth)acrylate (U) include aliphatic (meth)acrylates such as 2-hydroxyethyl acrylate, 2-hydroxypropyl acrylate, 4-hydroxybutyl acrylate, glycerol diacrylate, trimethylolpropane diacrylate, pentaerythritol triacrylate, and dipentaerythritol pentaacrylate; and

(meth)acrylates having an aromatic ring in the molecular structure thereof, such as 4-hydroxyphenyl acrylate, β-hydroxyphenethyl acrylate, 4-hydroxyphenethyl acrylate, 1-phenyl-2-hydroxyethyl acrylate, 3-hydroxy-4-acetylphenyl acrylate, and 2-hydroxy-3-phenoxypropyl acrylate. These compounds may be used alone or in combination.

Preferred among these compounds (u2) having a hydroxyl group and a (meth)acryloyl group in the molecular structure thereof are aliphatic (meth)acrylates having two or more (meth)acryloyl groups in the molecular structure thereof, such as glycerol diacrylate, trimethylolpropane diacrylate, pentaerythritol triacrylate, and dipentaerythritol pentaacrylate. Such compounds allow the fine inorganic particles (A) to be stably dispersed and can form a cured coating having high surface hardness and good scratch resistance. More preferred are aliphatic (meth)acrylates having three or more (meth)acryloyl groups in the molecular structure thereof, such as pentaerythritol triacrylate and dipentaerythritol pentaacrylate, which can form a cured coating having a higher surface hardness.

The urethane (meth)acrylate (U) may be manufactured, for example, by reacting the polyisocyanate (u1) with the compound (u2) having a hydroxyl group and a (meth)acryloyl group in the molecular structure thereof in the temperature range of 20° C. to 120° C., optionally using a commonly known and used urethanization catalyst. The ratio [(NCO)/(OH)] of the number of moles of isocyanate groups of the polyisocyanate (u1) to the number of moles of hydroxyl groups of the compound (u2) may be 1/0.95 to 1/1.05.

The thus-prepared urethane (meth)acrylate (U) preferably has a weight average molecular weight (Mw) of 800 to 20,000, more preferably 900 to 1,000. Such a urethane (meth)acrylate is more effective in dispersing the fine inorganic particles (A), provides a viscosity suitable for coating for the resin composition, and has good compatibility with the acrylic polymer (X) when they are used in combination.

The epoxy (meth)acrylate (E) may be, for example, a reaction product of a compound (e1), other than the acrylic polymer (Y1) and the compound (Z2), having an epoxy group in the molecular structure thereof with a compound (e2) having a (meth)acryloyl group and a carboxyl group in the molecular structure thereof.

Examples of compounds (e1), having an epoxy group in the molecular structure thereof, used as a raw material for the epoxy (meth)acrylate (E) include polyglycidyl ethers of aliphatic polyols such as ethylene glycol, diethylene glycol, propylene glycol, 1,3-propanediol, 1,4-butanediol, 1,3-butanediol, 3-methyl-1,3-butanediol, 1,5-pentanediol, neopentyl glycol, 1,6-hexanediol, trimethylolethane, trimethylolpropane, and glycerol;

polyglycidyl ethers of aromatic polyols such as hydroquinone, 2-methylhydroquinone, 1,4-benzenedimethanol, 3,3′-biphenyldiol, 4,4′-biphenyldiol, biphenyl-3,3′-dimethanol, biphenyl-4,4′-dimethanol, bisphenol A, bisphenol B, bisphenol F, bisphenol S, 1,4-naphthalenediol, 1,5-naphthalenediol, 2,6-naphthalenediol, naphthalene-2,6-dimethanol, and 4,4′,4″-methylidynetrisphenol;

polyglycidyl ethers of polyether-modified polyols prepared by ring-opening polymerization of aliphatic and aromatic polyols with various cyclic ethers such as ethylene oxide, propylene oxide, tetrahydrofuran, ethyl glycidyl ether, propyl glycidyl ether, butyl glycidyl ether, phenyl glycidyl ether, and allyl glycidyl ether;

polyglycidyl ethers of lactone-modified polyols prepared by polycondensation of aliphatic and aromatic polyols with lactones such as ε-caprolactone;

bisphenol epoxy resins such as bisphenol A epoxy resins, bisphenol B epoxy resins, bisphenol F epoxy resins, and bisphenol S epoxy resins; and

novolac epoxy resins such as phenol novolac epoxy resins and cresol novolac epoxy resins. These compounds may be used alone or in combination.

Preferred among these compounds are compounds having a bisphenol backbone in the molecular structure thereof, including diglycidyl ethers of bisphenols such as bisphenol A, bisphenol B, bisphenol F, and bisphenol S, diglycidyl ethers of polyether-modified derivatives of these bisphenols, diglycidyl ethers of lactone-modified derivatives of these bisphenols, and bisphenol epoxy resins. Such compounds can form a cured coating having high surface hardness and good scratch resistance.

Examples of compounds (e2), having a (meth)acryloyl group and a carboxyl group in the molecular structure thereof, used as a raw material for the epoxy (meth)acrylate (E) include (meth)acrylic acid; unsaturated monocarboxylic acids having an ester bond, such as β-carboxyethyl (meth)acrylate, 2-acryloyloxyethyl succinate, 2-acryloyloxyethyl phthalate, 2-acryloyloxyethyl hexahydrophthalate, and lactone-modified derivatives thereof; maleic acid; and carboxyl-containing polyfunctional (meth)acrylates prepared by reacting acid anhydrides such as succinic anhydride and maleic anhydride with hydroxyl-containing polyfunctional (meth)acrylate monomers such as pentaerythritol triacrylate. These compounds may be used alone or in combination.

Preferred among these compounds is (meth)acrylic acid, which can form a cured coating having a higher surface hardness and a better scratch resistance, more preferably acrylic acid, which also provides good curability for a radical-polymerizable composition.

The epoxy (meth)acrylate (E) may be manufactured, for example, by reacting a compound (e1) having an aromatic ring backbone and an epoxy group in the molecular structure thereof with the compound (e2) having a (meth)acryloyl group and a carboxyl group in the molecular structure thereof in the temperature range of 100° C. to 120° C., optionally using an esterification catalyst such as triphenylphosphine. The ratio [(Ep)/(COOH)] of the number of moles of epoxy groups of the compound (e1) to the number of moles of carboxyl groups of the compound (e2) may be 1/1 to 1.05/1.

The thus-prepared epoxy (meth)acrylate (E) preferably has a weight average molecular weight (Mw) of 350 to 5,000, more preferably 500 to 4,000. Such an epoxy (meth)acrylate can form a cured coating having high surface hardness and good scratch resistance.

These resin components (B) having a (meth)acryloyl group in the molecular structure thereof may be used alone or in combination. Particularly preferred is the acrylic polymer (X) having (meth)acryloyl groups in the molecular structure thereof, which allows the fine inorganic particles (A) to be stably dispersed and can form a coating having a good balance of blocking resistance, transparency, and scratch resistance. More preferably, the acrylic polymer (X) is used in combination with the (meth)acrylate monomer (M) and the urethane (meth)acrylate (U). Such resin components can form a coating having a higher surface hardness and a better scratch resistance and provides a low viscosity suitable for coating for the active-energy-radiation-curable resin composition.

If the resin component (b) used in the present invention contains the above resin components (B) having a (meth)acryloyl group in the molecular structure thereof, the acrylic polymer (X) having (meth)acryloyl groups in the molecular structure thereof is preferably present in an amount of 5 to 55 parts by mass, more preferably 10 to 45 parts by mass, even more preferably 15 to 35 parts by mass, based on 100 parts by mass of the total amount of the resin components (B) having a (meth)acryloyl group in the molecular structure thereof. Such a resin component allows the fine inorganic particles (A) to be stably dispersed and can form a coating having a good balance of blocking resistance, transparency, and scratch resistance.

The resin composition used in the present invention may contain an organic solvent (S) in addition to the fine inorganic particles (A) and the resin component (b). If the resin composition contains the acrylic polymer (X), the organic solvent used in the present invention is preferably, but not limited to, an organic solvent (S1) having an oxyalkylene structure in the molecular structure thereof or a ketone solvent (S2). Such solvents are effective in dissolving the acrylic polymer (X). The organic solvent (S1) having an oxyalkylene structure in the molecular structure thereof or the ketone solvent (S2) is preferably present in an amount of 40 to 90 parts by mass based on 100 parts by mass of the resin composition. Such a resin composition has good coatability.

Examples of organic solvents (S1) having an oxyalkylene structure in the molecular structure thereof include cyclic ether solvents such as tetrahydrofuran (THF) and dioxolane; and glycol ether solvents such as ethylene glycol monomethyl ether, ethylene glycol dimethyl ether, ethylene glycol monoethyl ether, ethylene glycol diethyl ether, ethylene glycol monopropyl ether, ethylene glycol monoisopropyl ether, ethylene glycol monobutyl ether, diethylene glycol monomethyl ether, diethylene glycol dimethyl ether, diethylene glycol monoethyl ether, diethylene glycol diethyl ether, diethylene glycol monoisopropyl ether, diethylene glycol monobutyl ether, triethylene glycol monomethyl ether, triethylene glycol dimethyl ether, propylene glycol monomethyl ether, propylene glycol dimethyl ether, propylene glycol monopropyl ether, propylene glycol monobutyl ether, dipropylene glycol monomethyl ether, and dipropylene glycol dimethyl ether. These solvents may be used alone or in combination. Preferred among these solvents are glycol ether solvents, more preferably propylene glycol monomethyl ether, propylene glycol dimethyl ether, propylene glycol monopropyl ether, and propylene glycol monobutyl ether, even more preferably propylene glycol monomethyl ether. Such solvents can form a coating having particularly high blocking resistance.

Examples of ketone solvents (S2) include methyl ethyl ketone, methyl n-propyl ketone, methyl isopropyl ketone, methyl n-butyl ketone, methyl isobutyl ketone, methyl n-amyl ketone, methyl n-hexyl ketone, diethyl ketone, ethyl n-butyl ketone, di-n-propyl ketone, diisobutyl ketone, cyclohexanone, and phorone. Preferred among these solvents are methyl ethyl ketone and methyl isobutyl ketone, which are particularly effective in dissolving the acrylic polymer (X).

If the resin composition used in the present invention contains an acrylic polymer (X) manufactured by solution polymerization as the resin component (b), the solvent used in the manufacture of the acrylic polymer (X) may be directly used. The organic solvents (S) may be used alone or in combination.

If the resin composition according to the present invention contains organic solvents other than the organic solvent (S1) having an oxyalkylene structure in the molecular structure thereof and the ketone solvent (S2), the organic solvent (S1) having an oxyalkylene structure in the molecular structure thereof or the ketone solvent (S2) is preferably present in an amount of 60 parts by mass or more, more preferably 85 parts by mass or more, based on 100 parts by mass of all organic solvent components. Such a resin composition can form a coating having good blocking resistance and has good storage stability.

As described above, the resin composition used in the present invention contains the fine inorganic particles (A) and the resin component (b) as essential components. Preferably, the resin composition contains, as essential components, fine inorganic particles (A) having an average particle size of 95 to 250 nm, an acrylic polymer (X) having (meth)acryloyl groups in the molecular structure thereof and having a weight average molecular weight (Mw) of 3,000 to 80,000, and the organic solvent (S).

The optimum content of the fine inorganic particles (A) in the resin composition varies depending on the solvent used. If the organic solvent (S) is the organic solvent (S1) having an oxyalkylene structure in the molecular structure thereof, the resin composition used in the present invention preferably contains, as essential components, fine inorganic particles (A) having an average particle size of 95 to 250 nm, the resin component (B) having a (meth)acryloyl group in the molecular structure thereof, and the organic solvent (S1) having an oxyalkylene structure in the molecular structure thereof, and the fine inorganic particles (A) are preferably present in an amount of 30 to 55 parts by mass based on 100 parts by mass of the nonvolatile components. Such a resin composition can form a coating having good blocking resistance, transparency, and scratch resistance.

If the organic solvent (S) is the ketone solvent (S2), the resin composition used in the present invention preferably contains, as essential components, fine inorganic particles (A) having an average particle size of 95 to 250 nm, the resin component (B) having a (meth)acryloyl group in the molecular structure thereof, and the ketone solvent (S2), and the fine inorganic particles (A) are preferably present in an amount of 45 to 60 parts by mass based on 100 parts by mass of the nonvolatile components. Such a resin composition can form a coating having good blocking resistance, transparency, and scratch resistance.

The resin composition used in the present invention may optionally contain a dispersant for stably dispersing the fine inorganic particles (A) in the composition. Examples of dispersants include phosphoric acid esters such as isopropyl acid phosphate, triisodecyl phosphite, and ethylene-oxide-modified phosphoric acid dimethacrylate. These compounds may be used alone or in combination. Preferred among these compounds is ethylene-oxide-modified phosphoric acid dimethacrylate, which is effective in promoting dispersion.

Examples of commercially available dispersants include “Kayamar PM-21” and “Kayamar PM-2” available from Nippon Kayaku Co., Ltd. and “Lightester P-2M” available from Kyoeisha Chemical Co., Ltd.

The dispersant, when used, is preferably present in an amount of 0.1 to 5.0 parts by mass based on 100 parts by mass of the resin composition. Such a resin composition has a higher storage stability.

The resin composition used in the present invention may further contain additives such as ultraviolet absorbers, antioxidants, silicon-containing additives, organic beads, fluorine-containing additives, rheology control agents, defoamers, release agents, antistatic agents, antifogging agents, colorants, organic solvents, and inorganic fillers.

Examples of ultraviolet absorbers include triazines such as 2-[4-{(2-hydroxy-3-dodecyloxypropyl)oxy}-2-hydroxyphenyl]-4,6-bis(2,4-dimethylphenyl)-1,3,5-triazine and 2-[4-{(2-hydroxy-3-tridecyloxypropyl)oxy}-2-hydroxyphenyl]-4,6-bis(2,4-dimethylphenyl)-1,3,5-triazine, 2-(2′-xanthenecarboxy-5′-methylphenyl)benzotriazole, 2-(2′-o-nitrobenzyloxy-5′-methylphenyl)benzotriazole, 2-xanthenecarboxy-4-dodecyloxybenzophenone, and 2-o-nitrobenzyloxy-4-dodecyloxybenzophenone.

Examples of antioxidants include hindered phenol antioxidants, hindered amine antioxidants, organosulfur antioxidants, and phosphate antioxidants. These compounds may be used alone or in combination.

Examples of silicon-containing additives include polyorganosiloxanes having an alkyl group or a phenyl group, polydimethylsiloxanes having a polyether-modified acrylic group, and polydimethylsiloxanes having a polyester-modified acrylic group, including dimethylpolysiloxane, methylphenylpolysiloxane, cyclic dimethylpolysiloxane, methylhydrogenpolysiloxane, polyether-modified dimethylpolysiloxane copolymers, polyester-modified dimethylpolysiloxane copolymers, fluorine-modified dimethylpolysiloxane copolymers, and amino-modified dimethylpolysiloxane copolymers. Examples of commercially available silicon-containing additives include “TEGO Rad 2200N”, “TEGO Rad 2300”, and “TEGO Rad 2100” available from Evonik Degussa, “UV3500” available from BYK-Chemie, and “Paintad 8526” and “SH-29PA” available from Dow Corning Toray Co., Ltd. These compounds may be used alone or in combination.

Examples of organic beads include polymethyl methacrylate beads, polycarbonate beads, polystyrene beads, polyacrylonitrile-styrene beads, silicone beads, glass beads, acrylic beads, benzoguanamine resin beads, melamine resin beads, polyolefin resin beads, polyester resin beads, polyamide resin beads, polyimide resin beads, polyethylene fluoride resin beads, and polyethylene resin beads. These organic beads preferably have an average size of 1 to 10 μm. These beads may be used alone or in combination.

Examples of fluorine-containing additives include the “Megafac” series available from DIC corporation. These compounds may be used alone or in combination.

Examples of antistatic agents include pyridinium, imidazolium, phosphonium, ammonium, and lithium salts of bis(trifluoromethanesulfonyl)imide and bis(fluorosulfonyl)imide. These compounds may be used alone or in combination.

The various additives are preferably used in such amounts that they are sufficiently effective but do not interfere with ultraviolet curing, for example, 0.01 to 40 parts by mass based on 100 parts by mass of the resin composition.

If the resin composition according to the present invention contains a photopolymerizable resin component (b), it preferably contains a photoinitiator. Examples of photoinitiators include various benzophenones such as benzophenone, 3,3′-dimethyl-4-methoxybenzophenone, 4,4′-bisdimethylaminobenzophenone, 4,4′-bisdiethylaminobenzophenone, 4,4′-dichlorobenzophenone, Michler's ketone, and 3,3′,4,4′-tetra(t-butylperoxycarbonyl)benzophenone;

xanthones and thioxanthones such as xanthone, thioxanthone, 2-methylthioxanthone, 2-chlorothioxanthone, and 2,4-diethylthioxanthone; various acyloin ethers such as benzoin, benzoin methyl ether, benzoin ethyl ether, and benzoin isopropyl ether;

α-diketones such as benzil and diacetyl; sulfides such as tetramethylthiuram disulfide and p-tolyl disulfide; various benzoic acids such as 4-dimethylaminobenzoic acid and ethyl 4-dimethylaminobenzoate; and

3,3′-carbonyl-bis(7-diethylamino)coumarin, 1-hydroxycyclohexyl phenyl ketone, 2,2′-dimethoxy-1,2-diphenylethan-1-one, 2-methyl-1-[4-(methylthio)phenyl]-2-morpholinopropan-1-one, 2-benzyl-2-dimethylamino-1-(4-morpholinophenyl)-butan-1-one, 2-hydroxy-2-methyl-1-phenylpropan-1-one, 2,4,6-trimethylbenzoyldiphenylphosphine oxide, bis(2,4,6-trimethylbenzoyl)phenylphosphine oxide, 1-[4-(2-hydroxyethoxy)phenyl]-2-hydroxy-2-methyl-1-propan-1-one, 1-(4-isopropylphenyl)-2-hydroxy-2-methylpropan-1-one, 1-(4-dodecylphenyl)-2-hydroxy-2-methylpropan-1-one, 4-benzoyl-4′-methyldimethyl sulfide, 2,2′-diethoxyacetophenone, benzyl dimethyl ketal, benzyl β-methoxyethyl acetal, methyl o-benzoylbenzoate, bis(4-dimethylaminophenyl) ketone, p-dimethylaminoacetophenone, α,α-dichloro-4-phenoxyacetophenone, pentyl-4-dimethylaminobenzoate, 2-(o-chlorophenyl)-4,5-diphenylimidazolyl dimer, 2,4-bis-trichloromethyl-6-[di-(ethoxycarbonylmethyl)amino]phenyl-S-triazine, 2,4-bis-trichloromethyl-6-(4-ethoxyl)phenyl-S-triazine, 2,4-bis-trichloromethyl-6-(3-bromo-4-ethoxy)phenyl-S-triazineanthraquinone, 2-t-butylanthraquinone, 2-amylanthraquinone, and β-chloroanthraquinone. These compounds may be used alone or in combination.

Preferred among these photoinitiators are 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, thioxanthone and thioxanthone derivatives, 2,2′-dimethoxy-1,2-diphenylethan-1-one, 2,4,6-trimethylbenzoyldiphenylphosphine oxide, bis(2,4,6-trimethylbenzoyl)phenylphosphine oxide, 2-methyl-1-[4-(methylthio)phenyl]-2-morpholino-1-propanone, and 2-benzyl-2-dimethylamino-1-(4-morpholinophenyl)-butan-1-one. Such photoinitiators, when used alone or in a mixture thereof, provide a coating composition with high curability that has activity for light in a wider wavelength range.

Examples of commercially available photoinitiators include “Irgacure 184”, “Irgacure 149”, “Irgacure 261”, “Irgacure 369”, “Irgacure 500”, “Irgacure 651”, “Irgacure 754”, “Irgacure 784”, “Irgacure 819”, “Irgacure 907”, “Irgacure 1116”, “Irgacure 1664”, “Irgacure 1700”, “Irgacure 1800”, “Irgacure 1850”, “Irgacure 2959”, “Irgacure 4043”, and “Darocur 1173” available from Ciba Specialty Chemicals; “Lucirin TPO” available from BASF; “Kayacure DETX”, “Kayacure MBP”, “Kayacure DMBI”, “Kayacure EPA”, and “Kayacure OA” available from Nippon Kayaku Co., Ltd.; “Vicure 10” and “Vicure 55” available from Stauffer Chemical; “Trigonal P1” available from Akzo; “Sandoray 1000” available from Sandoz; “Deep” available from Apjohn; and “Quantacure PDO”, “Quantacure ITX”, and “Quantacure EPD” available from Ward Blenkinsop.

The photoinitiator is preferably used in such an amount that it functions sufficiently as a photoinitiator but does not cause precipitation of crystals or degrade the physical properties of a coating, for example, 0.05 to 20 parts by mass, more preferably 0.1 to 10 parts by mass, based on 100 parts by mass of the resin composition.

The resin composition according to the present invention may contain various photosensitizers in combination with the photoinitiator. Examples of photosensitizers include amines, ureas, sulfur-containing compounds, phosphorus-containing compounds, chlorine-containing compounds, and nitriles and other nitrogen-containing compounds.

The resin composition used in the present invention contains the fine inorganic particles (A) and the resin component (b) as essential components. Specifically, the resin composition can be prepared, for example, by dispersing the fine inorganic particles (a) used as a raw material for the fine inorganic particles (A) in the resin component (b). Specific examples of dispersion processes include processes using dispersers, dispersion machines equipped with stirring blades such as turbine blades, paint shakers, roller mills, ball mills, attritors, sand mills, and bead mills. If the fine inorganic particles (a) are fine wet-process silica particles, any of the above dispersion machines can be used to prepare a homogenous and stable dispersion. If the fine inorganic particles (a) are fine dry-process silica particles, a ball mill or a bead mill is preferably used to prepare a homogenous and stable dispersion.

An example ball mill suitable for use in the manufacture of the resin composition used in the present invention is a wet ball mill including a vessel charged with media, a rotating shaft, stirring blades having an axis of rotation coaxial with the rotating shaft and configured to rotate as the rotating shaft rotates, a raw material inlet disposed on the vessel, a dispersion outlet disposed on the vessel, and a shaft seal disposed at a position where the rotating shaft extends through the vessel. The shaft seal includes two mechanical seal units, each including a seal portion sealed with an external seal liquid.

That is, an example method for manufacturing the resin composition used in the present invention uses a wet ball mill including a vessel charged with media, a rotating shaft, stirring blades having an axis of rotation coaxial with the rotating shaft and configured to rotate as the rotating shaft rotates, a raw material inlet disposed on the vessel, a dispersion outlet disposed on the vessel, and a shaft seal disposed at a position where the rotating shaft extends through the vessel. The shaft seal includes two mechanical seal units, each including a seal portion sealed with an external seal liquid. This method includes supplying raw materials including, as essential components, the fine inorganic particles (a) and the resin component (b) from the inlet to the vessel of the wet ball mill, mixing the raw materials with the media in the vessel with stirring by rotating the rotating shaft and the stirring blades to crush the fine inorganic particles (a) and to disperse the fine inorganic particles (a) in the resin component, and discharging the dispersion from the outlet.

This method will now be described in greater detail with reference to the drawings, where an example wet ball mill structure is illustrated.

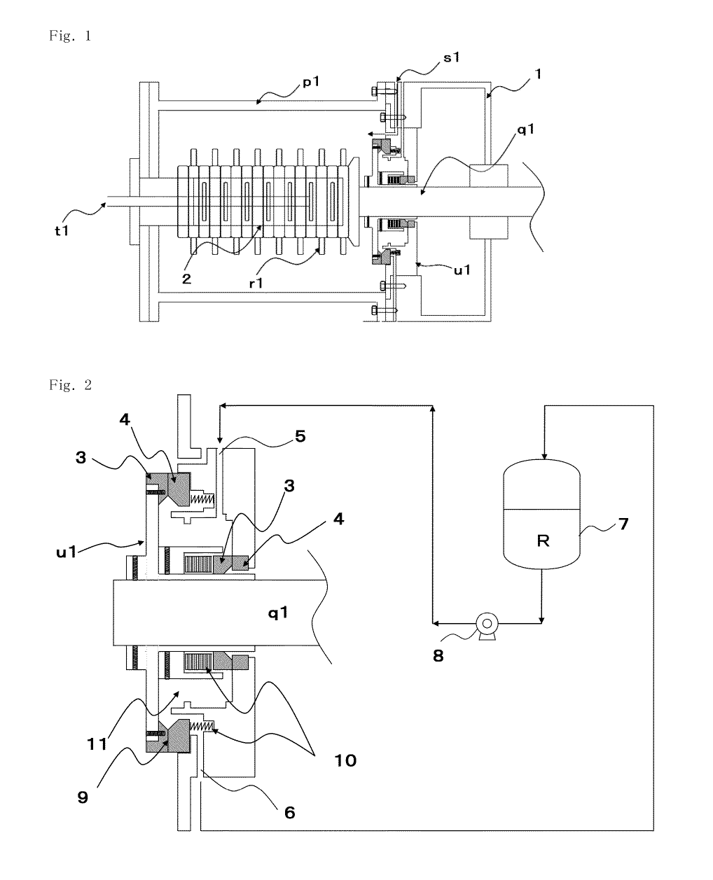

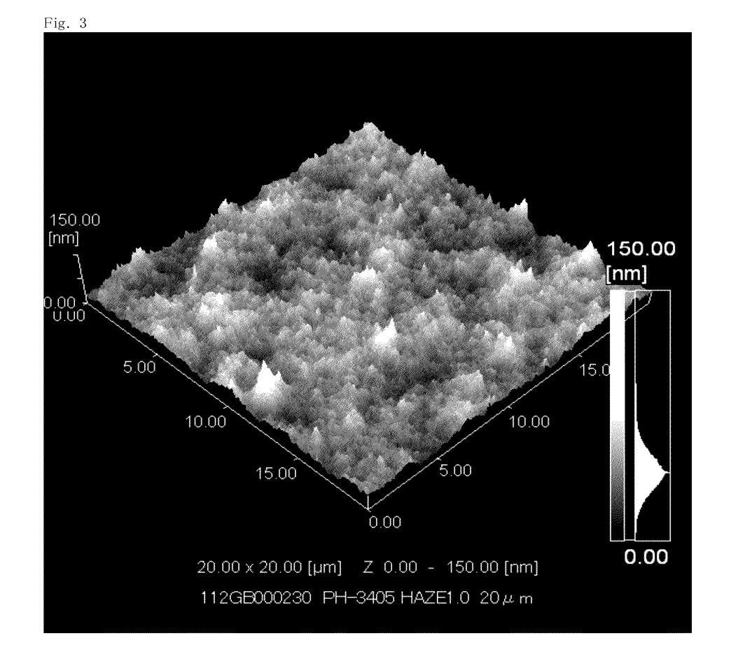

The wet ball mill shown in FIG. 1 includes a vessel (p1) charged with media, a rotating shaft (q1), stirring blades (r1) having an axis of rotation coaxial with the rotating shaft (q1) and configured to rotate as the rotating shaft rotates, a raw material inlet (s1) disposed on the vessel (p1), a dispersion outlet (t1) disposed on the vessel (p1), and a shaft seal (u1) disposed at a position where the rotating shaft extends through the vessel. The shaft seal (u1) includes two mechanical seal units, each including a seal portion sealed with an external seal liquid. For example, the shaft seal (u1) may have the structure shown in FIG. 2.

To manufacture the resin composition according to the present invention using the wet ball mill, the fine inorganic particles (a) and the resin component (b) may be supplied to and mixed and dispersed in the wet ball mill. During this process, the organic solvent (S), the dispersant, and the various additives may be supplied to the wet ball mill together with the fine inorganic particles (a) and the resin component (b) before they are mixed and dispersed. Alternatively, the fine inorganic particles (a) and the resin component (b) may be supplied to and mixed and dispersed in the wet ball mill before the organic solvent (S), the dispersant, and the various additives are added to the resulting mixture. Preferably, the fine inorganic particles (a), the resin component (b), the organic solvent (S), the dispersant, and the various additives are supplied to and mixed and dispersed in the wet ball mill, which requires a simpler manufacturing process. The photoinitiator is preferably added to the resulting dispersion later to avoid problems such as gelling during dispersion.

In the wet ball mill shown in FIG. 1, the raw materials are supplied through the inlet (s1) in FIG. 1 to the vessel (p1). In the vessel (p1), which is charged with media, the raw materials are stirred and mixed with the media as the stirring blades (r1) rotate with the rotation of the rotating shaft (q1) to crush the fine inorganic particles (a) and to disperse the fine inorganic particles (a) in the resin component (b) and other components. The rotating shaft (p1) has an inner cavity with an opening facing the outlet (t1). A screen-type separator 2 serving as a separator is disposed in the cavity, and a channel leading to the outlet (t1) is defined inside the separator 2. The dispersion in the vessel (p1) is forced from the opening of the rotating shaft (q1) through the separator 2 disposed therein by the supply pressure of the raw materials. The separator 2 allows only the dispersion containing the fine inorganic particles (A), which have small particle sizes, to pass while blocking the media, which have large particle sizes. Thus, only the dispersion is discharged from the outlet (t1), with the media remaining in the vessel (p1).

The wet ball mill includes the shaft seal (u1) shown in FIG. 2. The shaft seal (u1) includes two mechanical seal units, each including a rotating ring 3 fixed to the shaft (q1) and a fixed ring 4 fixed to a housing 1 of the shaft seal in FIG. 1 such that they form a seal portion. The rotating rings 3 and the fixed rings 4 of the two units are oriented in the same direction. As used herein, “seal portion” refers to a pair of sliding surfaces formed by the rotating ring 3 and the fixed ring 4. A liquid seal space 11 is defined between the two mechanical seal units and has an external seal liquid inlet 5 and an external seal liquid outlet 6 in communication therewith. An external seal liquid (R) is circulated as it is supplied from an external seal liquid tank 7 through the external seal liquid inlet 5 to the liquid seal space 11 by a pump 8 and is then returned through the external seal liquid outlet 6 to the tank 7. Thus, the liquid seal space 11 is filled with the external seal liquid (R) in a liquid-tight manner, and gaps 9 defined between the rotating rings 3 and the fixed rings 4 in the seal portions are filled with the external seal liquid (R). The external seal liquid (R) lubricates and cools the sliding surfaces of the rotating rings 3 and the fixed rings 4.

The inlet pressure of the external seal liquid (R) and the pressure of springs 10 are set so as to achieve a balance between the force P1 with which the fixed rings 4 are pressed against the rotating rings 3 by the inlet pressure of the seal liquid (R), the force P2 with which the fixed rings 4 are pressed against the rotating rings 3 by the springs 10, and the force P3 with which the fixed rings 4 are separated from the rotating rings 3 by the inlet pressure of the seal liquid (R). This allows the gaps 9 between the rotating rings 3 and the fixed rings 4, which form sliding surfaces, to be filled with the external seal liquid (R) in a liquid-tight manner and thus prevents the resin component (b) from entering the gaps 9. If the resin component (b) flows into the gaps 9 and, particularly, if the resin component (b) contains the resin component (B) having a (meth)acryloyl group in the molecular structure thereof, mechanoradicals would be generated from the resin component (B) having a (meth)acryloyl group in the molecular structure thereof during the sliding of the rotating rings 3 and the fixed rings 4. These mechanoradicals might induce the polymerization of the (meth)acryloyl group of the resin component (B) and thus cause gelling and thickening. This risk is avoided by the use of the wet ball mill according to the present invention, which includes a shaft seal like the shaft seal (u1).

The shaft seal like the shaft seal (u1) may be, for example, a tandem mechanical seal. Examples of commercially available wet ball mills Y including a tandem mechanical seal as a shaft seal include the “LMZ” series available from Ashizawa Finetech Ltd.

The external seal liquid (R) is a nonreactive liquid. For example, if the resin component (b) contains the acrylic polymer (X), the external seal liquid (R) may be selected from the various organic solvents listed as examples of organic solvents used in the manufacture of the acrylic polymer (X). Preferred among these solvents is the same solvent used in the manufacture of the acrylic polymer (X). Specific examples of solvents include ketone solvents and glycol ether solvents, more preferably methyl ethyl ketone, methyl isobutyl ketone, propylene glycol monomethyl ether, propylene glycol dimethyl ether, propylene glycol monopropyl ether, and propylene glycol monobutyl ether, even more preferably methyl isobutyl ketone and propylene glycol monomethyl ether.

The media charged in the vessel (p1) in FIG. 1 may be selected, for example, from various microbeads. Examples of materials for microbeads include zirconia, glass, titanium oxide, copper, and zirconia silicate. Particularly preferred are zirconia microbeads, which have the highest hardness and thus suffer the least wear of the above microbeads.

The media preferably has an average particle size (median size) of 10 to 1,000 μm. Such media can be smoothly separated from the slurry through the screen-type separator 2 in FIG. 1, require a relatively short period of time to disperse the fine inorganic particles (a) because of its high ability to crush the fine inorganic particles (a), and do not excessively impact the fine inorganic particles (a) and thus are unlikely to result in the overdispersion of the fine inorganic particles (a).

Overdispersion is the phenomenon in which fresh active surfaces form as the fine inorganic particles collapse and cause them to reaggregate. Overdispersion results in gelling of the dispersion.

The amount of media charged in the vessel (p1) in FIG. 1 is preferably 75% to 90% by volume of the vessel capacity. This requires the least power for dispersion and thus allows most efficient crushing.

The stirring blades (r1) are preferably rotated at a tip peripheral speed of 5 to 20 m/sec, more preferably 8 to 20 m/sec. This results in a larger impact upon collision of the media with the fine inorganic particles (a) and therefore a higher dispersion efficiency.

When such a wet ball mill is used to manufacture the resin composition according to the present invention, it may be manufactured either by a batch process or by a continuous process. The continuous process may be either a circulatory process in which the slurry is removed and is then supplied again or a non-circulatory process. Preferred among these processes is the circulatory process, which has high production efficiency and yields a homogeneous dispersion.

When such a wet ball mill is used to manufacture the resin composition according to the present invention, it may be manufactured by a two-step process including a predispersion step using relatively large media with a median size of 400 to 1,000 μm and a main dispersion step using relatively small media with a median size of 15 to 400 μm.

The predispersion step uses relatively large media with a median size of 200 to 1,000 μm. This media applies a large impact force to the fine inorganic particles (a) upon collision and is therefore effective in crushing the fine inorganic particles (a), which have a larger particle size. This media is used to crush the fine inorganic particles (A) used as a raw material to a certain particle size. The main dispersion step uses relatively small media with a median size of 15 to 400 μm. Although this media applies a smaller impact force to the fine inorganic particles (a) upon collision, the media collides with the fine inorganic particles (a) more frequently than media with a larger particle size because a larger number of particles are present in the same volume. This media is used to crush the fine inorganic particles (a) that have been crushed to a certain particle size in the predispersion step into finer particles. The predispersion step is preferably performed until the slurry completes one to three cycles in the vessel (p1). An extended predispersion step could result in overdispersion.

A coating according to the present invention is made of a resin composition containing the fine inorganic particles (A) and the resin component (b) as essential components, preferably an active-energy-radiation-curable resin composition containing, as essential components, fine inorganic particles (A) having an average particle size of 95 to 250 nm, the resin component (B) having a (meth)acryloyl group in the molecular structure thereof, and the organic solvent (S).

The coating according to the present invention can be formed, for example, by applying the resin composition to various substrates and then curing the resin composition by a method such as heating, irradiation with active energy radiation, or curing at room temperature. In this case, the resin composition may be directly applied to the surface of the member to be protected. Alternatively, a laminated film prepared by applying the resin composition to various types of plastic films at a thickness depending on the application may be used as a common protective film or an optical film such as an antireflection film, diffusing film, or prism sheet. Among these various applications, the coating according to the present invention is preferably used as a laminated film for its good blocking resistance, transparency, and scratch resistance. That is, the coating according to the present invention provides a laminated film resistant to blocking during storage in the form of a roll or stack and also having good transparency and scratch resistance.

Examples of plastic films used as substrates for laminated films include plastic films and plastic sheets made of polycarbonates, polymethyl methacrylate, polystyrene, polyesters, polyolefins, epoxy resins, melamine resins, triacetylcellulose resins, ABS resins, AS resins, norbornene resins, cyclic olefin resins, and polyimide resins. The coating according to the present invention exhibits high blocking resistance when used on any of these plastic films.

Among the above plastic films, triacetylcellulose films, which are suitable for polarizers in liquid crystal displays, are generally thin, i.e., have a thickness of 40 to 100 μm, making it difficult to achieve sufficient surface hardness even if a hard coat layer is formed thereon. According to the present invention, however, a triacetylcellulose film can be used as a substrate to provide a laminated film having high surface hardness and good scratch resistance. If a triacetylcellulose film is used as a substrate, the resin composition is preferably applied to a dry thickness of 0.5 to 20 μm, more preferably 1 to 10 μm. The resin composition may be applied, for example, by bar coating, Mayer bar coating, air knife coating, gravure coating, reverse gravure coating, offset printing, flexography, or screen printing.

Among the above plastic films, polyester films, including polyethylene terephthalate, generally have a thickness of about 100 to 300 μm. These films are inexpensive and easy to work and therefore are used in various applications such as touch panel displays. These films, however, are very soft, making it difficult to achieve sufficient surface hardness even if a hard coat layer is formed thereon. According to the present invention, however, a triacetylcellulose film can be used as a substrate to provide a laminated film having high surface hardness and good scratch resistance. If a polyethylene film is used as a substrate, the resin composition is preferably applied to a dry thickness of 0.5 to 100 μm, preferably 1 to 80 μm, even more preferably 1 to 30 μm, depending on the application. In general, a coating with a thickness of more than 30 μm tends to have low transparency. The coating according to the present invention, having good transparency, has a haze of 1.4 or less even if it is a thick coating with a thickness of more than 30 μm. The resin composition may be applied, for example, by bar coating, Mayer bar coating, air knife coating, gravure coating, reverse gravure coating, offset printing, flexography, or screen printing.

Among the above plastic films, polymethyl methacrylate films are suitable for applications requiring particularly high surface hardness, including front panels for liquid crystal displays, because they are relatively thick and robust, generally having a thickness of about 100 to 2,000 μm. If a polymethyl methacrylate film is used as a substrate, the resin composition is preferably applied to a dry thickness of 0.5 to 100 μm, more preferably 1 to 80 μm, even more preferably 1 to 30 μm, depending on the application. In general, a laminated film including a relatively thick film such as a polymethyl methacrylate film and a coating with a thickness of more than 30 μm formed thereon has high surface hardness, although it tends to have low transparency. The coating according to the present invention, having very high transparency, provides a laminated film combining high surface hardness and transparency. The resin composition may be applied, for example, by bar coating, Mayer bar coating, air knife coating, gravure coating, reverse gravure coating, offset printing, flexography, or screen printing.

As described above, the coating according to the present invention is made of a resin composition containing the fine inorganic particles (A) and the resin component (b) as essential components, and the resin component (b) may be selected from a wide variety of resins used in coating applications. The resin composition preferably contains the resin component (B) having a (meth)acryloyl group in the molecular structure thereof as the resin component (b). Such a resin composition allows the fine inorganic particles (A) to be stably dispersed and can be readily cured by irradiation with active energy radiation such as ultraviolet radiation. In this case, examples of active energy radiations for curing the coating include ultraviolet radiation and electron beams. If the coating is cured with ultraviolet radiation, an ultraviolet irradiation device is used that includes a xenon lamp, a high-pressure mercury lamp, or a metal halide lamp as a light source. The light intensity and the position of the light source, for example, are adjusted if necessary. If a high-pressure mercury lamp is used, the coating is preferably cured at a transport speed of 5 to 50 m/min relative to a lamp typically having a light intensity of 80 to 160 W/cm. If the coating is cured with an electron beam, it is preferably cured at a transport speed of 5 to 50 m/min using an electron beam accelerator typically having an acceleration voltage of 10 to 300 kV.

Although the coating according to the present invention is particularly suitable as a laminated film, it can also be used in other applications. For example, the coating according to the present invention is also suitable as a surface coating agent for various molded plastic products such as cellular phones, electric appliances, and automotive bumpers. In this case, the coating may be formed, for example, by coating, transfer, or sheet bonding.

Coating is a process including applying the resin composition to a molded product by spray coating or using a printing device such as a curtain coater, a roller coater, or a gravure coater to form a topcoat and then curing the topcoat by irradiation with active energy radiation.

A transfer process includes applying the resin composition to a substrate sheet having release properties to form a transfer sheet, bonding the transfer sheet to the surface of a molded product, removing the substrate sheet to transfer the topcoat to the surface of the molded product, and curing the topcoat by irradiation with active energy radiation. An alternative transfer process includes bonding the transfer sheet to the surface of a molded product, curing the topcoat by irradiation with active energy radiation, and removing the substrate sheet to transfer the topcoat to the surface of the molded product.

Sheet bonding is a process including bonding, to the surface of a molded plastic product, a protective sheet including a substrate sheet having thereon the coating according to the present invention or a protective sheet including a substrate sheet having thereon a coating of the coating composition and a decorative layer to form a protective layer on the surface of the molded product.

Among these processes, the coating composition according to the present invention is suitable for use in transfer and sheet bonding.

For transfer, a transfer sheet is first prepared. The transfer sheet can be manufactured, for example, by applying a resin composition containing both a thermosetting resin composition and an active-energy-radiation-curable resin composition to a substrate sheet and then semicuring the coating (to the B-stage) by heating.

To manufacture the transfer sheet, the coating composition according to the present invention is first applied to a substrate sheet. The coating composition may be applied, for example, by a coating process such as gravure coating, roller coating, spray coating, lip coating, or comma coating, or by a printing process such as gravure printing or screen printing. The coating composition is preferably applied such that the coating has a thickness of 0.5 to 30 μm, more preferably 1 to 6 μm, after curing. Such a coating has good wear resistance and chemical resistance.

After the resin composition is applied to the substrate sheet by the above process, the coating is dried and semicured (to the B-stage) by heating. The heating temperature is typically 55° C. to 160° C., preferably 100° C. to 140° C. The heating time is typically 30 seconds to 30 minutes, preferably 1 to 10 minutes, more preferably 1 to 5 minutes.

With this transfer sheet, a surface protective layer is formed on a molded product, for example, by bonding the B-stage resin composition layer of the transfer sheet to the molded product and then curing the resin composition layer by irradiation with active energy radiation. For example, a specific process includes bonding the B-stage resin composition layer of the transfer sheet to the surface of the molded product, removing the substrate sheet from the transfer sheet to transfer the B-stage resin composition layer of the transfer sheet to the surface of the molded product, and crosslinking and curing the resin layer by irradiation with active energy radiation (i.e., transfer). An alternative process includes injecting a resin into the cavity of a mold holding the transfer sheet to form a molded resin product while bonding the transfer sheet to the surface thereof, removing the substrate sheet to transfer the B-stage resin composition layer of the transfer sheet to the molded product, and crosslinking and curing the resin composition layer by irradiation with active energy radiation (i.e., simultaneous molding and transfer).

A specific sheet bonding process includes bonding a substrate sheet of a protective layer sheet prepared in advance to a molded product and then crosslinking and curing the B-stage resin layer by heating (i.e., post-bonding). An alternative process includes injecting a resin into the cavity of a mold holding the protective layer sheet to form a molded resin product while bonding the protective layer sheet to the surface thereof and then crosslinking and curing the resin layer by heating (i.e., simultaneous molding and transfer).

### EXAMPLES

The present invention is further illustrated by the following specific Examples of Manufacture and Examples, although these examples are not intended to limit the present invention. In these examples, all parts and percentages are by mass unless otherwise specified.

In the examples of the present invention, the weight average molecular weight (Mw) was measured using a gel permeation chromatograph (GPC) under the following conditions:

Measurement instrument: HLC-8220 from Tosoh Corporation

Columns: Guard Column H_{XL}-H from Tosoh Corporation
+TSKgel G5000H_{XL} from Tosoh Corporation
+TSKgel G4000H_{XL} from Tosoh Corporation
+TSKgel G3000H_{XL} from Tosoh Corporation
+TSKgel G2000H_{XL} from Tosoh Corporation

Detector: differential refractive index (RI) detector

Data processing: SC-8010 from Tosoh Corporation

Measurement conditions:
Column temperature: 40° C.
Solvent: tetrahydrofuran
Flow rate: 1.0 mL/min

Standards: polystyrene

Sample: microfiltered tetrahydrofuran solution with resin solids content of 0.4% by weight (100 μL)

### Fine Inorganic Particles (a) Used in Examples

Fine inorganic particles (a-1): “Aerosil 87200” available from Nippon Aerosil Co., Ltd., fine silica particles having primary average particle size of 12 nm and having (meth)acryloyl groups thereon

### Example of Manufacture 1

### Manufacture of Acrylic Polymer (X-1)

To a reactor equipped with a stirrer, a condenser, a dropping funnel, and a nitrogen inlet tube was charged 224 parts by mass of propylene glycol monomethyl ether (hereinafter abbreviated as “PGM”), and it was heated with stirring until the internal temperature reached 110° C. A mixture of 272 parts by mass of glycidyl methacrylate, 68 parts by mass of methyl methacrylate, and 20 parts by mass of t-butylperoxy-2-ethylhexanoate (“Perbutyl O” available from Nippon Nyukazai Co., Ltd.) was then added dropwise via the dropping funnel over 3 hours, and the mixture was maintained at 110° C. for 15 hours. After the mixture was cooled to 90° C., 0.1 part by mass of methoquinone and 138 parts by mass of acrylic acid were charged, and 5 parts by mass of triphenylphosphine was added. The mixture was then heated to 100° C., was maintained at that temperature for 8 hours, and was diluted with PGM to obtain 1,000 parts by mass of a solution of an acrylic polymer (X-1) in PGM (nonvolatile content: 50.0% by mass). The acrylic polymer (X-1) had the following properties: weight average molecular weight (Mw): 22,000, theoretical acryloyl equivalent on solids basis: 250 g/eq, hydroxyl value: 225 mg KOH/g.

### Example of Manufacture 2

### Manufacture of Acrylic Polymer (X-2)

The process in Example of Manufacture 1 was repeated except that PGM was replaced by methyl isobutyl ketone (hereinafter abbreviated as “MIBK”) to obtain 1,000 parts by mass of a solution of an acrylic polymer (X-2) in MIBK (nonvolatile content: 50.0% by mass). The acrylic polymer (X-2) had the following properties: weight average molecular weight (Mw): 22,000, theoretical acryloyl equivalent on solids basis: 250 g/eq, hydroxyl value: 225 mg KOH/g.

### Example of Manufacture 3

### Manufacture of Acrylic Polymer (X-3)

To a reactor equipped with a stirrer, a condenser, a dropping funnel, and a nitrogen inlet tube was charged 265 parts by mass of PGM, and it was heated with stirring until the internal temperature reached 110° C. A mixture of 144 parts by mass of glycidyl methacrylate, 200 parts by mass of methyl methacrylate, 68 parts by mass of cyclohexane methacrylate, and 12 parts by mass of t-butylperoxy-2-ethylhexanoate (“Perbutyl O” available from Nippon Nyukazai Co., Ltd.) was then added dropwise via the dropping funnel over 3 hours, and the mixture was maintained at 110° C. for 15 hours. After the mixture was cooled to 90° C., 0.1 part by mass of methoquinone and 73 parts by mass of acrylic acid were charged, and 5 parts by mass of triphenylphosphine was added. The mixture was then heated to 100° C., was maintained at that temperature for 8 hours, and was diluted with PGM to obtain 1,000 parts by mass of a solution of an acrylic polymer (X-3) in PGM (nonvolatile content: 50.0% by mass). The acrylic polymer (X-3) had the following properties: weight average molecular weight (Mw): 42,000, theoretical acryloyl equivalent on solids basis: 478 g/eq, hydroxyl value: 117 mg KOH/g.

### Example of Manufacture 4

### Manufacture of Acrylic Polymer (X-4)

To a reactor equipped with a stirrer, a condenser, dropping funnels, a nitrogen inlet tube, and an air inlet tube was charged 360 parts by mass of PGM, and it was heated with stirring in a nitrogen atmosphere until the internal temperature reached 110° C. A mixture of 187 parts by mass of isobornyl methacrylate, 3 parts by mass of methyl methacrylate, and 10 parts by mass of methacrylic acid and a mixture of 78 parts by mass of PGM and 2 parts by mass of t-butylperoxy-2-ethylhexanoate (“Perbutyl O” available from Nippon Nyukazai Co., Ltd.) were then simultaneously added dropwise via the dropping funnels over 3 hours, and the mixture was maintained at 110° C. for 1 hour. A mixture of 16.8 parts by mass of PGM and 0.2 part by mass of t-butylperoxy-2-ethylhexanoate (“Perbutyl O” available from Nippon Nyukazai Co., Ltd.) was further added dropwise, and the mixture was maintained at 110° C. for 30 minutes. To the reaction solution, a mixture of 1.5 parts by mass of tetrabutylammonium bromide, 0.1 part by mass of hydroquinone, and 4.4 parts by mass of PGM was added, and a mixture of 24.4 parts by mass of 4-hydroxybutyl acrylate glycidyl ether and 5 parts by mass of PGM was further added dropwise, with air being introduced, over 1 hour. The mixture was further reacted for 5 hours to obtain 692 parts by mass of a solution of an acrylic polymer (X-4) in PGM (nonvolatile content: 33.0% by mass). The acrylic polymer (X-4) had a weight average molecular weight (Mw) of 18,000.

### (Meth)acrylate Monomers (M) Used in Examples

(Meth)acrylate monomer (M-1): dipentaerythritol hexaacrylate

(Meth)acrylate monomer (M-2): pentaerythritol triacrylate

### Example of Manufacture 5

### Manufacture of Urethane (Meth)Acrylate (U-1)

To a reactor equipped with a stirrer were charged 166 parts by mass of hexamethylene diisocyanate, 0.2 part by mass of dibutyltin dilaurate, and 0.2 part by mass of methoquinone, and it was heated to 60° C. with stirring. To the mixture, 630 parts by mass of pentaerythritol triacrylate (“Aronix M-305” available from Toagosei Co., Ltd.) was added in 10 portions every 10 minutes. The mixture was further reacted for 10 hours. The reaction was terminated when it was determined that the isocyanate absorption at 22,500 cm⁻¹ disappeared in the infrared spectrum to obtain a urethane acrylate (U-1). The urethane acrylate (U-1) had the following properties: weight average molecular weight (Mw): 1,400, theoretical acryloyl equivalent: 120 g/eq.

### Example 1

A slurry containing 40 parts by mass of the solution of the acrylic polymer (X-1) in PGM prepared in Example of Manufacture 1 (the acrylic polymer (X-1) was present in an amount of 20 parts by mass per 20.0 parts by mass), 35 parts by mass of dipentaerythritol hexaacrylate (M-1), 45 parts by mass of the fine inorganic particles (a-1), and 130 parts by mass of PGM and having a nonvolatile content of 40% by mass was mixed and dispersed in a wet ball mill (“Starmill LMZ015” available from Ashizawa Finetech Ltd.) to obtain a dispersion.

The dispersion was performed in the wet ball mill under the following conditions:

Media: zirconia beads with median size of 100 μm

Amount of resin composition charged in mill: 70% by volume of capacity

Tip peripheral speed of stirring blades: 11 m/sec

Flow rate of resin composition: 200 mL/min

Dispersion time: 60 minutes

To the resulting dispersion was added 2 parts by mass of a photoinitiator (“Irgacure #184” available from Ciba Specialty Chemicals). The dispersion was adjusted to a nonvolatile content of 35% by mass with PGM to obtain an active-energy-radiation-curable resin composition. The active-energy-radiation-curable resin composition was evaluated for its properties by the following various tests. The results are summarized in Table 1.

### Measurement of Average Particle Size of Fine Inorganic Particles (A)

The average particle size of the fine inorganic particles (A) in the active-energy-radiation-curable resin composition was measured with a particle size analyzer (“ELSZ-2” available Otsuka Electronics Co., Ltd.).

### Preparation of Laminated Film

The active-energy-radiation-curable resin composition was applied to a polyethylene terephthalate (hereinafter abbreviated as “PET”) film (“U-46” available from Toray Industries, Inc., thickness: 188 μm) using a bar coater such that the coating had a thickness of 10 μm after curing. The coating was dried at 70° C. for 1 minute and was then cured by irradiation with ultraviolet radiation from a high-pressure mercury lamp at a dose of 250 mJ/cm² under nitrogen to obtain a laminated film.

### Transparency Test on Laminated Film

The haze of the laminated film was measured with a “Haze Computer HZ-2” available from Suga Test Instruments Co., Ltd. A lower haze indicates a higher coating transparency.

### Measurement of Arithmetic Mean Roughness (Ra) of Resin Coating of Laminated Film

The Ra of the surface of the resin coating of the laminated film was measured with a scanning probe microscope (“SPM-9600” available from Shimadzu Corporation).

### Blocking Resistance Test on Surface of Resin Coating of Laminated Film

The laminated film was placed on a test film prepared under the following conditions such that the surfaces of the resin coatings of both films were in contact with each other. A weight of 500/cm² was placed on the films, and they were left standing at room temperature for 24 hours. A laminated film that adhered to the test film after they were left standing was rated as poor, whereas a laminated film that did not adhere to the test film after they were left standing was rated as good.

### Preparation of Test Film

A resin composition was prepared by mixing 100 parts by weight of Unidic 17-806 and 2 parts by mass of a photoinitiator (“Irgacure #184” available from Ciba Specialty Chemicals) and adjusting the mixture with ethyl acetate to a nonvolatile content of 35% by mass. The resin composition was applied to a polyethylene terephthalate film (thickness: 188 μm) using a bar coater such that the coating had a thickness of 10 μm after curing. The coating was dried at 70° C. for 1 minute and was then cured by irradiation with ultraviolet radiation from a high-pressure mercury lamp at a dose of 250 mJ/cm² under nitrogen to obtain a test film.

### Pencil Hardness Test on Laminated Film

The laminated film was evaluated for the surface hardness of the resin coating by a pencil scratch test at a load of 750 g according to JIS K 5400. The test was performed five times, and the pencil hardness of the coating was determined as the hardness immediately below the hardness at which a scratch occurred once or more.

### Steel Wool Resistance Test on Coating

A disc with a diameter of 2.4 cm was wrapped with 0.5 g of steel wool (Bonstar #0000″ available from Nippon Steel Wool Co., Ltd.) and was moved back and forth 100 times across the surface of the resin coating of the laminated film at a load of 1,000 gw. The hazes of the coating before and after testing were measured with a “Haze Computer HZ-2” available from Suga Test Instruments Co., Ltd., and the coating was evaluated based on the difference δH therebetween. A cured coating with a lower δH has a better scratch resistance.

### Example 2

An active-energy-radiation-curable resin composition was prepared as in Example 1 except that the composition was changed as shown in Table 1. The various tests were performed as in Example 1 except that the resin composition was applied such that the coating had a thickness of 5 μm after curing in the step of preparing a laminated film. The results are summarized in Table 1.

### Examples 3 to 7

Active-energy-radiation-curable resin compositions were prepared as in Example 1 except that the composition was changed as shown in Table 1. The various tests were performed as in Example 1. The results are summarized in Table 1.

### Comparative Example 1

An active-energy-radiation-curable resin composition for comparison was prepared by mixing 3 parts by weight of the acrylic polymer (X-4) prepared in Example of Manufacture 4, 99 parts by weight of pentaerythritol triacrylate, and 2 parts by mass of a photoinitiator (“Irgacure #184” available from Ciba Specialty Chemicals) and adjusting the mixture with PGM to a nonvolatile content of 35% by mass. This composition was tested as in Example 1. The results are summarized in Table 1.

TABLE 1

| | | | | | | | | Comparative |
|---|---|---|---|---|---|---|---|---|
| | Example 1 | Example 2 | Example 3 | Example 4 | Example 5 | Example 6 | Example 7 | Example 1 |
| Fine inorganic particles (a-1) | 45 | 45 | 55 | 40 | 45 | 40 | 40 | |
| Acrylic polymer (X-1) | 40 | 40 | | 40 | 40 | 40 | | |
| Acrylic polymer (X-2) | | | 40 | | | | | |
| Acrylic polymer (X-3) | | | | | | | 20 | |
| Acrylic polymer (X-4) | | | | | | | | 3 |
| (Meth)acrylate monomer (M-1) | 35 | 35 | 25 | 40 | 27 | 32 | 10 | |
| (Meth)acrylate monomer (M-2) | | | | | | | | 99 |
| Urethane (meth)acrylate (U-1) | | | | | 8 | 8 | 40 | |
| Organic solvent (S) | PGM | PGM | MBK | PGM | PGM | PGM | PGM | PGM |
| Average particle size of | 105 | 105 | 120 | 104 | 110 | 108 | 112 | — |
| fine inorganic particles (A) | | | | | | | | |
| Thickness of resin coating layer (μm) | 10 | 5 | 10 | 10 | 10 | 10 | 10 | 10 |
| Arithmetic mean roughness (Ra) (nm) | 9.06 | 12.3 | 7.02 | 2.54 | 11.23 | 3.89 | 6.96 | 50 |
| Haze of coating | 0.95 | 1.2 | 0.52 | 0.58 | 1.1 | 0.82 | 0.67 | 1.54 |
| Blocking resistance | Good | Good | Good | Good | Good | Good | Good | Poor |
| Pencil hardness | 4H | 2H | 4H | 4H | 4H | 4H | 4H | 2H |
| Steel wool resistance | 1.4 | 1.4 | 1.1 | 1.5 | 0.8 | 0.8 | 0.6 | 3.3 |

### REFERENCE SIGNS LIST

1 shaft seal housing
2 separator
p1 vessel
q1 rotating shaft
r1 stirring blade
s1 raw material inlet
t1 dispersion outlet
u1 shaft seal
3 rotating ring
4 fixed ring
5 external seal liquid inlet
6 external seal liquid outlet
7 external seal liquid tank
8 pump
9 gap formed between rotating ring 3 and fixed ring 4
10 spring
11 liquid seal space

1-23. (canceled)

24. An active-energy-radiation-curable resin composition comprising, as essential components, a resin component (B) having a (meth)acryloyl group in the molecular structure thereof and an organic solvent (S1) having an oxyalkylene structure in the molecular structure thereof, the composition comprising fine dry-process silica particles (A) having an average primary particle size of 3 to 100 nm in an amount of 30 to 55 parts by mass based on 100 parts by mass of the nonvolatile components, the fine dry-process silica particles (A) being dispersed such that the average particle size of the fine dry-process silica particles (A) in the composition is 95 to 250 nm as measured with a particle size analyzer.

25. An active-energy-radiation-curable resin composition comprising, as essential components, a resin component (B) having a (meth)acryloyl group in the molecular structure thereof and a ketone solvent (S2), the composition comprising fine dry-process silica particles (A) having an average primary particle size of 3 to 100 nm in an amount of 45 to 60 parts by mass based on 100 parts by mass of the nonvolatile components, the fine dry-process silica particles (A) being dispersed such that the average particle size of the fine dry-process silica particles (A) in the composition is 95 to 250 nm as measured with a particle size analyzer.

26. The active-energy-radiation-curable resin composition according to claim 24, wherein the fine dry-process silica particles (A) are dispersed such that the average particle size of the fine dry-process silica particles (A) in the composition is 100 to 150 nm as measured with a particle size analyzer.

27. The active-energy-radiation-curable resin composition according to claim 24, wherein the fine dry-process silica particles (A) are dry-process silica having thereon a modifier group including a (meth)acryloyl structure.

28. The active-energy-radiation-curable resin composition according to claim 24, wherein the resin component (B) having a (meth)acryloyl group in the molecular structure thereof comprises an acrylic polymer (X) having a weight average molecular weight (Mw) of 3,000 to 80,000 and having (meth)acryloyl groups in the molecular structure thereof.

29. The active-energy-radiation-curable resin composition according to claim 28, wherein the acrylic polymer (X) is a polymer prepared by reacting an acrylic polymer (Y) prepared by polymerizing, as an essential component, a compound (y) having a reactive functional group and a (meth)acryloyl group, with a compound (z) having a functional group capable of reacting with the reactive functional group of the compound (y) and a (meth)acryloyl group.

30. The active-energy-radiation-curable resin composition according to claim 29, wherein the acrylic polymer (Y) is a polymer prepared by polymerizing the compound (y) with another acrylic polymerizable monomer (v) in a mass ratio [(y)/(v)] of 20/80 to 95/5.

31. The active-energy-radiation-curable resin composition according to claim 24, further comprising a (meth)acrylate monomer (M) or a urethane (meth)acrylate (U).

32. A method for manufacturing an active-energy-radiation-curable resin composition using a wet ball mill including a vessel charged with media, a rotating shaft, stirring blades having an axis of rotation coaxial with the rotating shaft and configured to rotate as the rotating shaft rotates, a raw material inlet disposed on the vessel, a dispersion outlet disposed on the vessel, and a shaft seal disposed at a position where the rotating shaft extends through the vessel, the shaft seal including two mechanical seal units, each including a seal portion sealed with an external seal liquid, the method comprising supplying raw materials including, as essential components, aggregated fine dry-process silica particles (A) having an average primary particle size of 3 to 100 nm, a resin component (B) having a (meth)acryloyl group in the molecular structure thereof, and an organic solvent (S1) having an oxyalkylene structure in the molecular structure thereof from the inlet to the vessel of the wet ball mill; mixing the raw materials with the media in the vessel with stirring by rotating the rotating shaft and the stirring blades to crush the aggregated fine dry-process silica particles (A) and to disperse the fine dry-process silica particles (A) in the other components such that the average particle size of the fine dry-process silica particles (A) in the composition is 95 to 250 nm as measured with a particle size analyzer; and discharging the dispersion from the outlet.

33. A method for manufacturing an active-energy-radiation-curable resin composition using a wet ball mill including a vessel charged with media, a rotating shaft, stirring blades having an axis of rotation coaxial with the rotating shaft and configured to rotate as the rotating shaft rotates, a raw material inlet disposed on the vessel, a dispersion outlet disposed on the vessel, and a shaft seal disposed at a position where the rotating shaft extends through the vessel, the shaft seal including two mechanical seal units, each including a seal portion sealed with an external seal liquid, the method comprising supplying raw materials including, as essential components, aggregated fine dry-process silica particles (A) having an average primary particle size of 3 to 100 nm, a resin component (B) having a (meth)acryloyl group in the molecular structure thereof, and a ketone solvent (S2) from the inlet to the vessel of the wet ball mill; mixing the raw materials with the media in the vessel with stirring by rotating the rotating shaft and the stirring blades to crush the aggregated fine dry-process silica particles (A) and to disperse the fine dry-process silica particles (A) in the other components such that the average particle size of the fine dry-process silica particles (A) in the composition is 95 to 250 nm as measured with a particle size analyzer; and discharging the dispersion from the outlet.

34. A coating composition comprising the active-energy-radiation-curable resin composition according to claim 24.

35. A coating formed by curing the coating composition according to claim 34.

36. A transparent blocking-resistant laminated film comprising a coating layer formed by curing the resin composition according to claim 24 and a plastic film layer, the coating having an arithmetic mean surface height (Ra) of 1 to 30 nm and a haze of 1.4 or less.

37. The transparent blocking-resistant laminated film according to claim 36, wherein the coating has a thickness of 0.5 to 100 μm.

38. The active-energy-radiation-curable resin composition according to claim 25, wherein the fine dry-process silica particles (A) are dispersed such that the average particle size of the fine dry-process silica particles (A) in the composition is 100 to 150 nm as measured with a particle size analyzer.

39. The active-energy-radiation-curable resin composition according to claim 25, wherein the fine dry-process silica particles (A) are dry-process silica having thereon a modifier group including a (meth)acryloyl structure.

40. The active-energy-radiation-curable resin composition according to claim 25, wherein the resin component (B) having a (meth)acryloyl group in the molecular structure thereof comprises an acrylic polymer (X) having a weight average molecular weight (Mw) of 3,000 to 80,000 and having (meth)acryloyl groups in the molecular structure thereof.

41. The active-energy-radiation-curable resin composition according to claim 25, further comprising a (meth)acrylate monomer (M) or a urethane (meth)acrylate (U).

42. A coating composition comprising the active-energy-radiation-curable resin composition according to claim 25.

43. A transparent blocking-resistant laminated film comprising a coating layer formed by curing the resin composition according to claim 25 and a plastic film layer, the coating having an arithmetic mean surface height (Ra) of 1 to 30 nm and a haze of 1.4 or less.
